(19) United States
(12) Patent Application Publication
(10) Pub. No.: US 2026/0343615 A1
(43) Pub. Date: Oct. 29, 2026

(54) TIMING ADVANCE WITH MULTIPLE PRACH TRANSMISSIONS USING DIFFERENT SPATIAL FILTERS

(71) Applicant: QUALCOMM Incorporated, San Diego, CA (US)

(72) Inventors: Hung Dinh LY, San Diego, CA (US); Kexin XIAO, Shanghai (CN)

(21) Appl. No.: 19/112,439

(22) PCT Filed: Sep. 28, 2022
(86) PCT No.: PCT/CN2022/122009

§ 371 Date: Mar. 17, 2025

(51) Int. Cl. H04W 74/0833; H04W 56/00; H04W 74/00

(52) U.S. Cl. CPC H04W 74/0833; H04W 56/0045; H04W 74/006

(57) ABSTRACT

An apparatus for wireless communication transmits a plurality of physical random access channel (PRACH) signals using a set of different spatial filters, each of the plurality of PRACH signals being transmitted during a respective PRACH occasion of a plurality of PRACH occasions. The apparatus receives a random access response message including at least a timing advance (TA). The apparatus transmits a scheduled uplink message based on the TA and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the TA.

### BACKGROUND

### Technical Field

The present disclosure relates generally to communication systems, and more particularly, to timing advance with multiple physical random access channel (PRACH) transmissions using different beams.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may use different spatial filters (e.g., different beams) for multiple PRACH signal transmissions. For example, each of the PRACH signal transmissions may be a repetition of an initial message (e.g., Msg1) of a four-step RACH procedure. A network node (e.g., a base station) may observe different propagation delays for the multiple PRACH signal transmissions. A network node may provide a timing advance (TA) (also referred to as a TA value) to the UE in a random access response (RAR) message for transmission of a scheduled uplink message (e.g., the third message (Msg3) of a four-step RACH procedure). If the UE uses a spatial (Tx) filter of a PRACH signal transmission that does not correspond to the indicated TA value, the network node may not be able to receive the scheduled uplink message (e.g., Msg3). The aspects described herein may enable a UE to use a spatial filter associated with an indicated TA value to improve message transmissions and/or receptions and enhance coverage during a RACH procedure.

In an aspect of the disclosure, a method, a computer-readable medium, and an apparatus are provided. The apparatus transmits a plurality of physical random access channel (PRACH) signals using a set of different spatial filters, each of the plurality of PRACH signals being transmitted during a respective PRACH occasion of a plurality of PRACH occasions; receives a random access response message including at least a timing advance value; and transmits a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value.

In an aspect of the disclosure, a method, a computer-readable medium, and an apparatus are provided. The apparatus receives a plurality of PRACH signals using a set of different spatial filters, each of the plurality of PRACH signals being received during a respective PRACH occasion of a plurality of PRACH occasions; transmits one or more random access response messages including at least a timing advance value; and receives a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal received in a second PRACH occasion, where the second PRACH signal is associated with the timing advance value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a signal flow diagram illustrating an example four-step random access channel (RACH) procedure performed between a UE and a network node.

FIG. 6 is a diagram illustrating an example of a four-step RACH procedure based on multiple beams.

FIG. 7 is a diagram illustrating example groups of physical random access channel (PRACH) occasions in accordance with various aspects of the disclosure.

FIG. 8 is a diagram illustrating the example groups of PRACH occasions in accordance with various aspects of the disclosure.

FIG. 9 is a signal flow diagram in accordance with various aspects of the disclosure.

FIG. 10 is a diagram illustrating the example groups of PRACH occasions in accordance with various aspects of the disclosure.

FIG. 11 is a diagram illustrating an example of a four-step RACH procedure based on multiple beams in accordance with various aspects of the disclosure.

FIG. 12 is a signal flow diagram in accordance with various aspects of the disclosure.

FIG. 13 is a diagram illustrating an example of a four-step RACH procedure based on multiple beams in accordance with various aspects of the disclosure.

FIG. 14 is a flowchart of a method of wireless communication.

FIG. 15 is a conceptual data flow diagram illustrating the data flow between different means/components in an example apparatus.

FIG. 16 is a diagram illustrating an example of a hardware implementation for an apparatus employing a processing system.

FIG. 17 is a flowchart of a method of wireless communication.

FIG. 18 is a conceptual data flow diagram illustrating the data flow between different means/components in an example apparatus.

FIG. 19 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

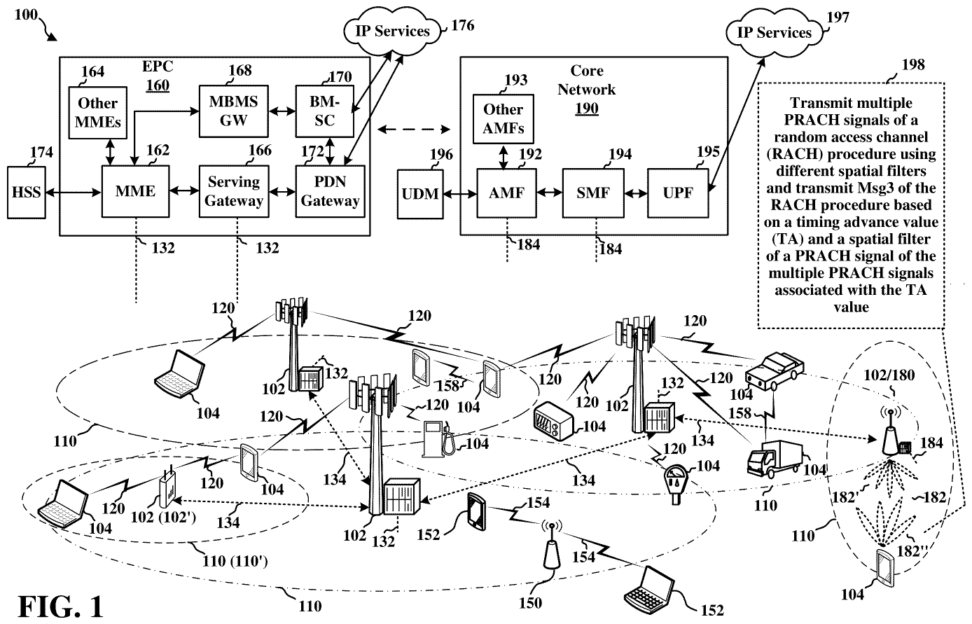

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to transmit multiple physical random access channel (PRACH) signals of a random access channel (RACH) procedure using different spatial filters and transmit a third message (Msg3) of the RACH procedure based on a timing advance (TA) value and a spatial filter of a PRACH signal of the multiple PRACH signals associated with the TA value (198). Although the following description may be focused on 5G NR, the concepts described herein may be applicable to other similar areas, such as LTE, LTE-A, CDMA, GSM, and other wireless technologies.

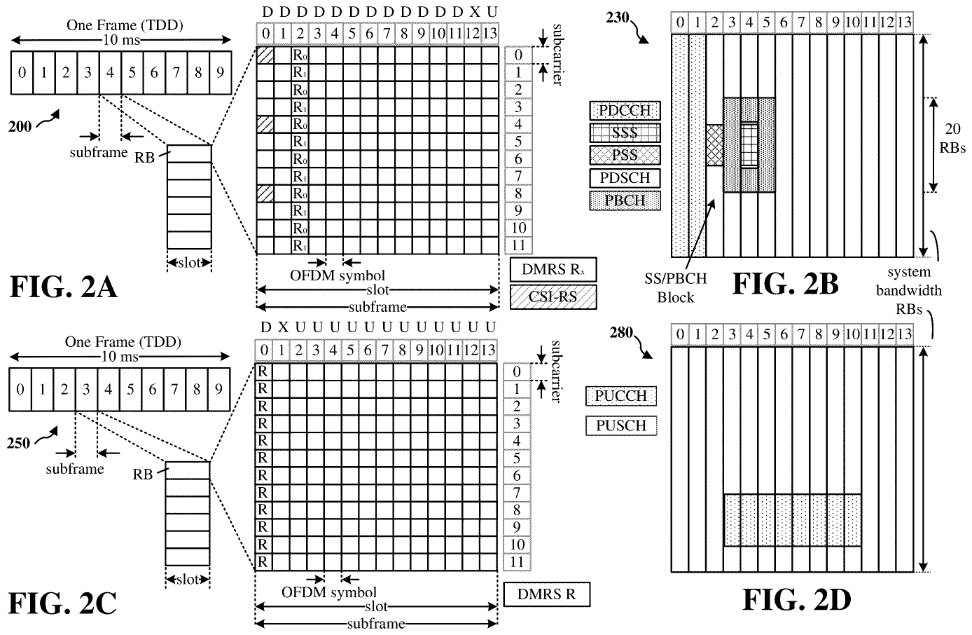

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}* 15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (abbreviated herein as SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

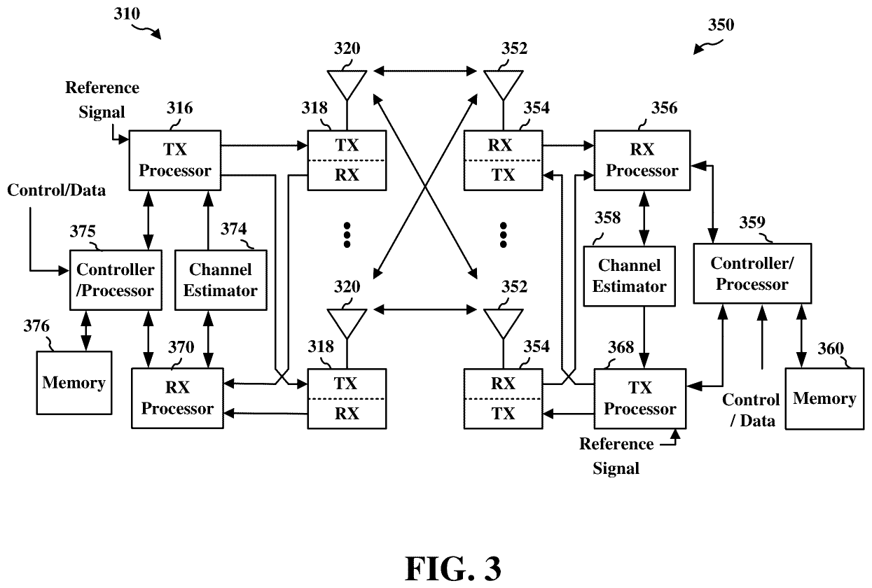

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

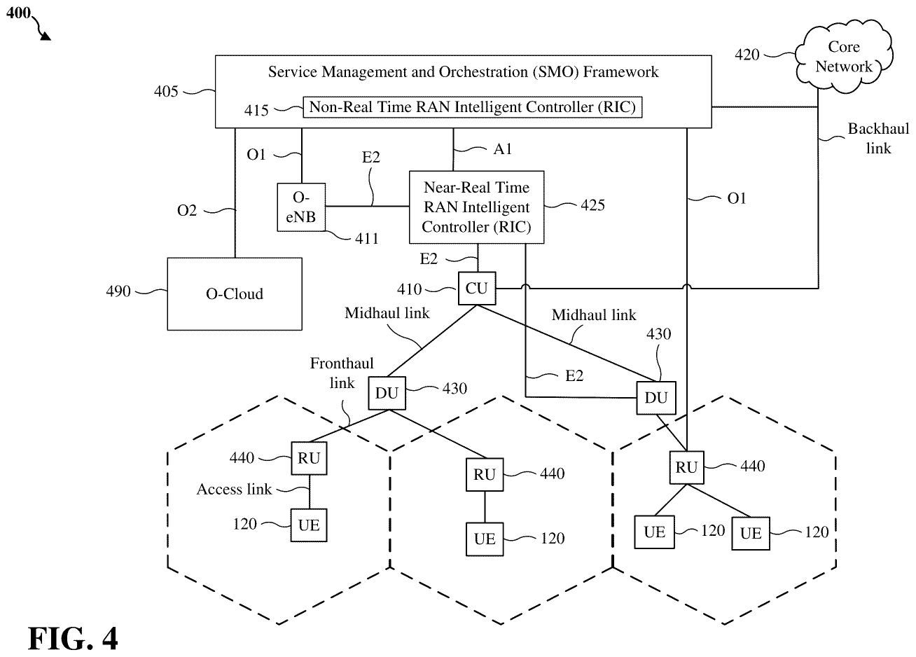

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 120 via one or more radio frequency (RF) access links. In some implementations, the UE 120 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an Al interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

A network node (e.g., a base station) may observe different propagation delays for multiple PRACH signal transmissions from a UE when the UE uses different spatial filters (e.g., different beams) for the multiple PRACH signal transmissions. For example, each of the PRACH signal transmissions may be a repetition of an initial message (e.g., Msg1) of a four-step RACH procedure.

A UE uses a timing advance (TA) (also referred to as a TA value) indicated in a random access response (RAR) from the network node for transmission of a scheduled uplink message (e.g., the third message (Msg3) of a four-step RACH procedure) to compensate for a propagation delay. If the UE uses a spatial (Tx) filter of a PRACH signal transmission that does not correspond to the indicated TA value, the network node may not be able to receive the scheduled uplink message (e.g., Msg3). The aspects described herein may enable a UE to use a spatial filter (also referred to as a spatial domain filter), such as a spatial transmission (Tx) filter, associated with an indicated TA value to improve message transmissions and/or receptions and enhance coverage during a RACH procedure.

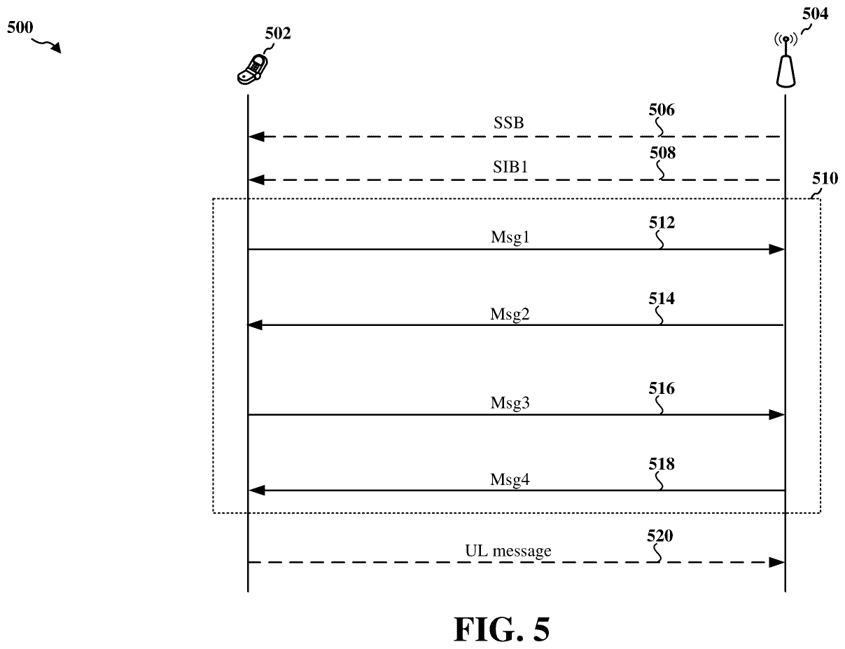

FIG. 5 is a signal flow diagram 500 illustrating an example four-step random access channel (RACH) procedure 510 performed between a UE 502 and a network node 504. The network node 504 may be a base station. The four-step RACH procedure 510 may be a contention-based random access procedure (CBRA) and may be initiated by the UE 502 for initial access to a network (e.g., to achieve UL synchronization with the network node 504).

The UE 502 may receive an SSB 506 and a system information block (SIB), such as a SIB1 508. The SIB1 508 may include RACH configuration information. The UE 502 may receive the SIB1 508 using PDSCH resources indicated by the PDCCH.

The UE 502 may initiate the four-step RACH procedure 510 by transmitting a PRACH preamble in message 1 (Msg1) 512. Message 1 (Msg1) 512 may be referred to as a physical random access channel message and may be the initial message of the four-step RACH procedure 510. Upon detection of the PRACH preamble, the network node 504 responds with message 2 (Msg2) 514 including a random access response (RAR). The network node 504 may use a PDCCH for scheduling and a PDSCH for transmission of message 2 (Msg2) 514. Message 2 514 may include a timing advance, a UL grant for transmission of message 3 (Msg3) 516 by the UE 502 using the PUSCH, and a temporary cell radio network temporary identifier (TC-RNTI).

The UE 502 may transmit message 3 (Msg3) 516 using the PUSCH. Message 3 (Msg3) 516 may include an RRC connection request, a scheduling request, a buffer status, and/or other information (e.g., small data). The network node 504 may transmit a contention resolution via message 4 (Msg4) 518 using the PDCCH for scheduling and the PDSCH for transmission of message 4 (Msg4) 518. The UE 502 may optionally transmit a UL message 520 (e.g., on the PUCCH or PDSCH).

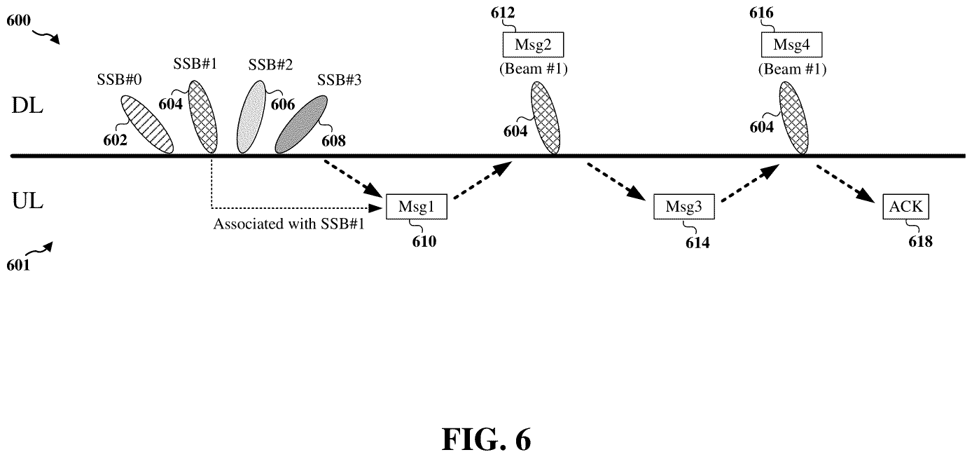

FIG. 6 is a diagram illustrating an example of a four-step RACH procedure based on multiple beams. The DL communications 600 in FIG. 6 may be performed by a network node and the UL communications 601 may be performed by a UE. The network node may transmit multiple SSBs using different beams, such as a first SSB (SSB #0) using a first beam (Beam #0) 602, a second SSB (SSB #1) using a second beam (Beam #1) 604, a third SSB (SSB #2) using a third beam (Beam #2) 606, and a fourth SSB (SSB #3) using a fourth beam (Beam #3) 606. Each SSB may be mapped to one or more PRACH occasions (ROs). The mapping between SSBs and ROs (also referred to as SSB-RO mapping) may be indicated to the UE in SIB.

The UE may select an SSB based on an RSRP measurement and may select a PRACH resource associated with the selected SSB. For example, the UE may be configured to select the SSB having the highest measured RSRP. In the example of FIG. 6, the UE may determine that SSB #1 has the highest RSRP and may select SSB #1. The UE may transmit an initial message (e.g., Msg1 610) of the four-step RACH procedure using a spatial filter associated with the selected SSB (e.g., SSB #1). For example, the UE may transmit Msg1 610 using the second beam (Beam #1) 604 used for SSB #1. Msg1 610 may include a PRACH signal. In some examples, a PRACH signal includes a PRACH preamble (also referred to as a random access preamble or more simply as a preamble).

If Msg1 610 is received at the network node, the network node may use the spatial filter used for Msg1 610 to transmit a second message (e.g., Msg2 612) of the four-step RACH procedure. For example, the network node may transmit Msg2 612 using the second beam (Beam #1) 604.

If Msg2 612 is received at the UE, the UE may transmit a third message (e.g., Msg3 614) of the four-step RACH procedure using the same spatial filter used for transmission of Msg1 610. For example, the UE may transmit Msg3 614 using the second beam (Beam #1) 604.

If Msg3 614 is received at the network node, the network node may use the spatial filter used for Msg2 612 to transmit a fourth message (e.g., Msg4 616) of the four-step RACH procedure. For example, the network node may transmit Msg4 616 using the second beam (Beam #1) 604.

If Msg4 616 is received at the UE, the UE may transmit an ACK message (e.g., ACK 618) using the same spatial filter used for transmission of Msg1 610. For example, the UE may transmit ACK 618 using the second beam (Beam #1) 604.

In some examples, a medium access control (MAC) entity at the network node may generate an RAR message (e.g., Msg2) of the four-step RACH procedure in response to a PRACH signal (e.g., Msg1 including a PRACH preamble) from the UE and may transmit the RAR message on a downlink shared channel (DL-SCH). The DL-SCH may serve as a downlink transport channel and may be carried in the PDSCH. The UE may decode a PDCCH to obtain the DCI that indicates scheduling information for the PDSCH carrying the RAR message. The UE may receive the PDSCH based on the scheduling information included in the DCI.

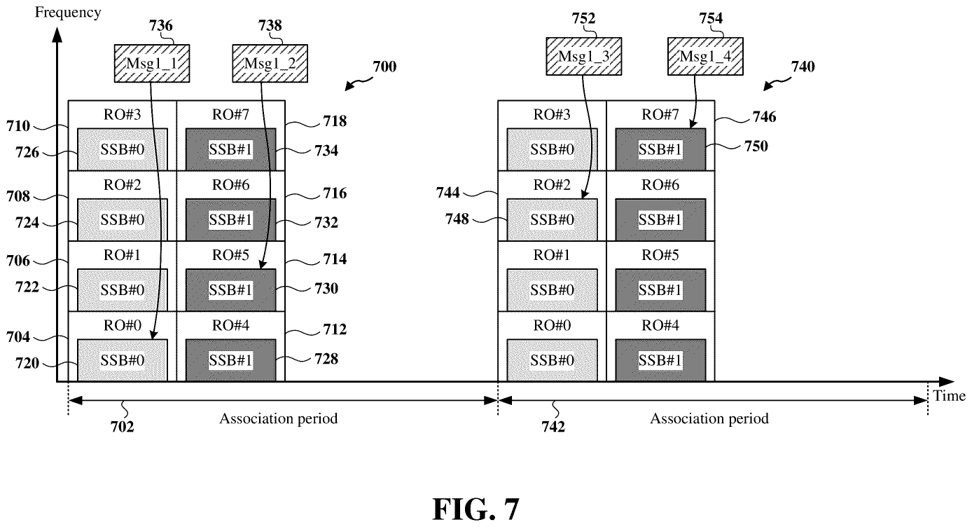

FIG. 7 is a diagram illustrating example groups of PRACH occasions in accordance with various aspects of the present disclosure. In the example of FIG. 7, a network node may configure a group of PRACH occasions within an association period, such as the group of PRACH occasions 700 within the association period 702 and the group of PRACH occasions 740 within the association period 742. For example, the group of PRACH occasions 700 may include eight PRACH occasions, such as PRACH occasion #0 (RO #0) 704, PRACH occasion #1 (RO #1) 706, PRACH occasion #2 (RO #2) 708, PRACH occasion #3 (RO #3) 710, PRACH occasion #4 (RO #4) 712, PRACH occasion #5 (RO #5) 714, PRACH occasion #6 (RO #6) 716, PRACH occasion #7 (RO #7) 718.

A UE may transmit a PRACH signal (e.g., a PRACH preamble) in one or more of the PRACH occasions in the groups of PRACH occasions 700, 740. Each PRACH occasion in a group of PRACH occasions (e.g., the group of PRACH occasions 700) may be associated with time and frequency resources for a PRACH signal transmission.

As shown in FIG. 7, each PRACH occasion in a group of PRACH occasions may be associated with an SSB. For example, PRACH occasion #0 (RO #0) 704, PRACH occasion #1 (RO #1) 706, PRACH occasion #2 (RO #2) 708, and PRACH occasion #3 (RO #3) 710 may be associated with a first SSB, shown as SSB #0 720, 722, 724, 726. Continuing with this example, PRACH occasion #4 (RO #4) 712, PRACH occasion #5 (RO #5) 714, PRACH occasion #6 (RO #6) 716, and PRACH occasion #7 (RO #7) 718 may be associated with a second SSB, shown as SSB #1 728, 730, 732, 734. For example, and as shown in FIG. 7, the group of PRACH occasions 740 in the association period 742 may have the same configuration of PRACH occasions and associated SSBs as the group of PRACH occasions 700.

It should be understood that the configuration of PRACH occasions and associated SSBs in FIG. 7 represents one possible example and that other combinations of PRACH occasions and associated SSBs are contemplated. In some examples, the group of PRACH occasions 700 may have more or fewer PRACH occasions.

Each SSB may be associated with a certain spatial filter. For example, a spatial filter may represent a beam. Accordingly, different spatial filters may represent different beams.

The UE may transmit multiple PRACH signals with different beams. In some examples, the UE may transmit four repetitions of the first message (Msg1) of a four-step RACH procedure including a PRACH signal (e.g., a PRACH preamble) using different beams. In some configurations, the UE may transmit one PRACH signal at a given time. For example, as shown in FIG. 7, the UE may transmit Msg1_1 736 in PRACH occasion #0 (RO #0) 704, Msg1_2 738 in PRACH occasion #5 (RO #5) 714, Msg1_3 752 in PRACH occasion #2 (RO #2) 744, and Msg1_4 754 in PRACH occasion #7 (RO #7) 746. In FIG. 7, PRACH occasion #2 (RO #2) 744 may be associated with SSB #0 748 and PRACH occasion #7 (RO #7) 746 may be associated with SSB #1 750.

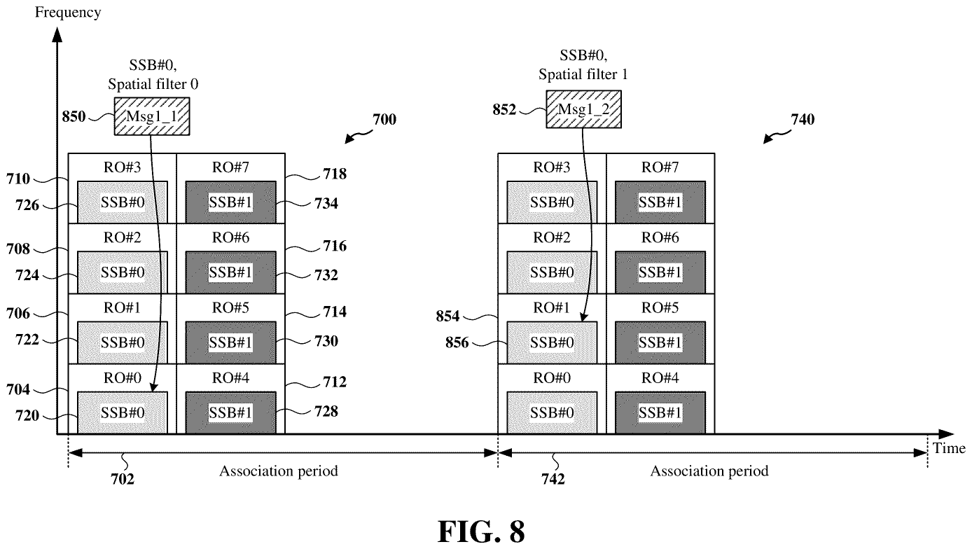

FIG. 8 is a diagram illustrating the example groups of PRACH occasions 700, 740 previously described with reference to FIG. 7 in accordance with various aspects of the present disclosure. In the example of FIG. 8, the UE may transmit two repetitions of the first message (Msg1) of a four-step RACH procedure including a PRACH signal (e.g., a PRACH preamble) using different beams. For example, as shown in FIG. 8, the UE may transmit Msg1_1 850 in PRACH occasion #0 (RO #0) 704 using a first spatial filter (indicated in FIG. 8 as spatial filter 0), and Msg1_2 852 in PRACH occasion #1 (RO #1) 854 using a second spatial filter (indicated in FIG. 8 as spatial filter 1). In FIG. 8, PRACH occasion #1 (RO #1) 854 may be associated with SSB #0 856.

The PDCCH may be scrambled with an RA-RNTI that is determined based on one or more indices associated with the PRACH occasion in which the PRACH signal (e.g., Msg1 including a Random Access Preamble) is transmitted. For example, the network node may scramble the cyclic redundancy check (CRC) of the PDCCH with the RA-RNTI. The RA-RNTI may be determined based on the time/frequency resources used for the transmission of the PRACH signal. In such examples, all UEs transmitting a PRACH signal on the same resource may have the same RA-RNTI and may be addressed by the same PDCCH. In some cases, the network node may scramble CRC bits for the PDCCH with the RA-RNTI to enable the UE to determine whether the PDCCH includes control information for the UE.

In some examples, the RA-RNTI associated with a PRACH occasion may be determined based on equation (1):

RA-RNTI=(1+s_id)+(14×t_id)+(14×80×f_id)+(14×80×8×ul_carrier_id) (equation 1)

where s_id represents an index of a first OFDM symbol of the PRACH occasion (e.g., 0<s_id<14), t_id represents an index of the first slot of the PRACH occasion in a system frame (e.g., 0<t_id<80), f_id represents an index of the PRACH occasion in the frequency domain (e.g., 0<f_id<8), and ul_carrier_id represents a UL carrier used for the Msg1 transmission (e.g., a random access preamble transmission). For example, each of s_id, t_id, f_id may be an integer value. In some examples, ul_carrier_id may be zero for a normal uplink (NUL) carrier or one for a supplementary uplink (SUL) carrier. In some examples, the subcarrier spacing to determine t_id may be based on the value of μ (e.g., the numerology 0 to 5 as described herein).

In some aspects, the transmission of multiple PRACH signals using different spatial filters as described herein may apply to FR1 and/or FR2 based on applicability. In some aspects, the transmission of multiple PRACH signals using different spatial filters may apply to short PRACH formats and/or other formats when applicable.

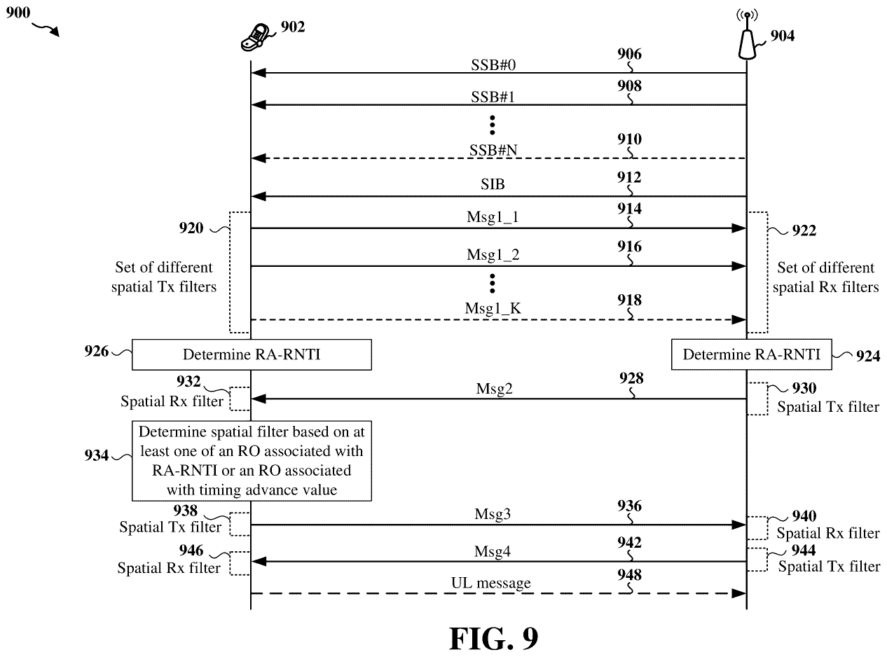

FIG. 9 is a signal flow diagram 900 in accordance with various aspects of the disclosure. The signal flow diagram 900 includes a UE 902 and a network node 904.

The network node 904 may transmit multiple SSBs using spatial domain beam forming. For example, with reference to FIG. 9, the network node 904 may transmit a first SSB (SSB #0) 906 using a first beam (e.g., Beam #0) in a first time period, a second SSB (SSB #1) 908 using a second beam (e.g., Beam #1) in a second time period, and so on up to an Nth SSB (SSB #N) 910 using an Nth beam (e.g., Beam #N) in an Nth time period, where N is an integer in the range 0 to M−1, and M represents the total number of transmitted SSBs. For example, each beam (e.g., Beam #0, Beam #1, Beam #N) of the multiple SSBs may be associated with a different direction and/or size. In some examples, each of the multiple SSBs (e.g., the first SSB (SSB #0) 906, the second SSB (SSB #1) 908, the Nth SSB (SSB #N) 910) may carry the same system information.

Each of the multiple SSBs (e.g., the first SSB (SSB #0) 906, the second SSB (SSB #1) 908, the Nth SSB (SSB #N) 910) may be associated with a unique index. For example, the first SSB 906 may have an index 0, the second SSB 908 may have an index 1, and the Nth SSB 910 may have an index N.

The UE 902 may receive one or more SIBs, such as SIB 912, from the network node 904. For example, the SIB 912 may be a SIB1. The SIB1 may include RACH configuration information. The UE 902 may receive the SIB 912 using PDSCH resources indicated by the PDCCH.

The UE 902 may transmit multiple PRACH signals using a set of different spatial filters (e.g., a set of different spatial domain Tx filters 920), where each of the multiple PRACH signals is transmitted during a different PRACH occasion. Each PRACH signal may be an initial message (e.g., Msg1) of a four-step PRACH procedure and may include a PRACH preamble as described herein. For example, the UE 902 may transmit a first PRACH signal (e.g., Msg1_1 914) including a PRACH preamble, a second PRACH signal (e.g., Msg1_2 916) including the PRACH preamble, and so on up to a Kth PRACH signal (Msg1_K 918) including the PRACH preamble, where K is a positive integer, and where K>2. The network node 904 may receive the multiple PRACH signals using a set of different spatial filters (e.g., a set of different spatial domain Rx filters 922).

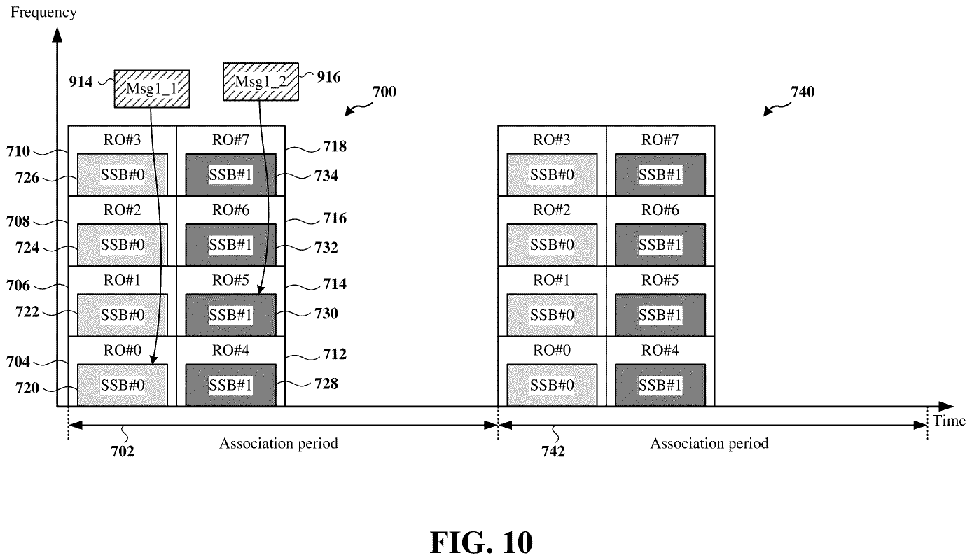

Example transmissions of two PRACH signals by the UE 902 using two different spatial filters (e.g., a first spatial filter and a second spatial filter) during different PRACH occasions will now be described with reference to FIG. 10. FIG. 10 is a diagram illustrating the example groups of PRACH occasions 700, 740 previously described with reference to FIG. 7 in accordance with various aspects of the present disclosure. In the example of FIG. 10, the UE 902 may transmit two repetitions of the initial message (e.g., Msg1) of a four-step RACH procedure using different spatial filters. For example, as shown in FIG. 10, the UE 902 may transmit Msg1_1 914 in PRACH occasion #0 (RO #0) 704 using a first spatial filter associated with SSB #0 720, and Msg1_2 916 in PRACH occasion #5 (RO #5) 714 using a second spatial filter associated with SSB #1 730. In some examples, Msg1_2 916 may be a repetition of Msg1_1 914. In these examples, Msg1_1 914 and Msg1_2 916 may each include the same PRACH preamble.

Referring back to FIG. 9, at 924, the network node 904 may determine an RA-RNTI. In some examples, the network node 904 may determine the RA-RNTI based on equation (1) described herein. At 926, the UE 902 may also determine the RA-RNTI. In some examples, the UE 902 may determine the RA-RNTI based on equation (1) described herein.

The network node 904 may transmit a second message (Msg2) 928 of the four-step RACH procedure. The second message (Msg2) 928 may be referred to as a random access response message. The network node 904 may use the PDCCH for scheduling and the PDSCH for transmission of the second message (Msg2) 928. The second message (Msg2) 928 of the four-step RACH procedure may include a timing advance (TA) value, a UL grant for transmission of a scheduled UL message (e.g., a third message (Msg3) 928 of the four-step RACH procedure) by the UE 902 using the PUSCH, and a TC-RNTI. The network node 904 may scramble the PDCCH for scheduling the transmission of the second message (Msg2) 928 based on the RA-RNTI.

The UE 902 may receive the second message (Msg2) 928 using the RA-RNTI. In some aspects, the UE 902 may receive the second message (Msg2) 928 based on a spatial filter (e.g., a spatial domain Rx filter 932) associated with a spatial filter (e.g., a spatial transmission Tx filter) used for the PRACH transmission in the PRACH occasion used for the RA-RNTI determination at 922.

At 934, the UE 902 may determine a spatial filter based on at least one of a PRACH occasion associated with the RA-RNTI or a PRACH occasion associated with the TA value included in the second message (Msg2) 928. For example, the UE 902 may decode the PDDCH for the second message (Msg2) 928 using the RA-RNTI and may receive the PDSCH based on information (e.g., resource information) in the PDCCH. The spatial filter may be a spatial domain Tx filter the UE 902 may use for a transmission of the third message (Msg3) 936 of the four-step RACH procedure.

It should be noted that the network node 904 may determine the TA value included in the second message (Msg2) 928 based on one of the multiple PRACH signals (e.g., Msg1_1 914 or Msg1_2 916). In some scenarios, the network node 904 may determine the TA value based on a PRACH signal transmitted in a PRACH occasion used for determination of the RA-RNTI. In other scenarios, the network node 904 may determine the TA value based on a PRACH signal transmitted in a PRACH occasion different from the PRACH occasion used for determination of the RA-RNTI.

In some aspects of the disclosure, the UE 902 may assume that the TA value indicated in the second message (Msg2) 924 is based on the PRACH signal transmission in the PRACH occasion used for the RA-RNTI determination at 926. In one example, the UE 902 may be configured to determine the RA-RNTI at 926 based on the PRACH occasion in which the first PRACH signal (e.g., Msg1_1 914) is transmitted for a given PRACH preamble. In this example, with reference to FIG. 10, the UE 902 may use the PRACH occasion #0 (RO #0) 704 associated with the first SSB (SSB #0) 906. The UE 902 may determine the spatial filter at 934 as the spatial filter used for the transmission of the first PRACH signal (e.g., Msg1_1 914) in the PRACH occasion #0 (RO #0) 704.

In other aspects of the disclosure, the UE 902 may receive an indication of a PRACH occasion that enables identification of the PRACH signal that the network node 904 used to determine the TA value. This approach may be applied in scenarios where the TA value indicated in the second message (Msg2) 928 of the four-step RACH procedure is based on a PRACH transmission in a PRACH occasion different from the PRACH occasion used for the RA-RNTI determination at 924. In one example implementation, the network node 904 may include the indication of the PRACH occasion in a random access response message (e.g., the second message (Msg2) 928 of the four-step RACH procedure) or in DCI. For example, the DCI may have a certain DCI format (e.g., DCI format 0_0 defined in 3GPP standard specifications) and the CRC bits belonging to the DCI format may be scrambled based on the TC-RNTI.

In some examples, the indication of the PRACH occasion may include at least one of an index of the PRACH occasion, time-frequency information of the PRACH occasion, or information relative to a reference PRACH occasion. For example, the reference PRACH occasion may be the PRACH occasion used for determination of the RA-RNTI at 926.

In some aspects of the disclosure, if the indication of the PRACH occasion that enables identification of the PRACH signal that the network node 904 used to determine the TA value is not received at the UE 902 (e.g., the network node 904 did not include the indication of the PRACH occasion in the second message (Msg2) 928 of the four-step RACH procedure), the UE 902 may assume that the TA value indicated in the second message (Msg2) 928 is based on the PRACH signal transmitted in the PRACH occasion used for the RA-RNTI determination at 926.

For example, if the indication is in DCI format 0_0 with CRC scrambled by TC-RNTI (e.g., for transmission of the third message (Msg3) 936 of the four-step RACH procedure), the UE 902 may transmit the first transmission of the third message (Msg3) 936 based on the second message (Msg2) 924 using the spatial filter of the PRACH transmission in the PRACH occasion used for the RA-RNTI computation at 926. In some aspects, if the UE 902 receives the indication of the PRACH occasion that enables identification of the PRACH signal that the network node 904 used to determine the TA value, the UE 902 may transmit a scheduled UL message (e.g., the third message (Msg3) 936 of the four-step RACH procedure) based on the TA value and the spatial filter used to transmit the PRACH signal in the indicated PRACH occasion. In other words, the spatial domain Tx filter 938 in FIG. 9 may be the spatial filter used to transmit the PRACH signal in the indicated PRACH occasion.

The UE 902 may transmit the third message (Msg3) 936 of the four-step RACH procedure based on the TA value and the spatial filter determined at 934. For example, the UE 902 may transmit the third message (Msg3) 936 using the spatial domain Tx filter 938.

The network node 904 may receive the third message (Msg3) 936 using the spatial domain Rx filter 940. The network node 904 may transmit the fourth message (Msg4) 942 in response to the third message (Msg3) 936 using the spatial domain Tx filter 944.

The UE 902 may receive the contention resolution message (e.g., the fourth message (Msg4) 930 of the four-step RACH procedure). In one example scenario, the UE 902 may receive the fourth message (Msg4) 930 using a spatial filter (e.g., a spatial domain Rx filter 946) associated with the spatial filter (e.g., a spatial Tx filter) used for the PRACH transmission in the PRACH occasion used for the RA-RNTI determination at 926. In another example scenario, the UE 902 may receive the fourth message (Msg4) 930 using a spatial filter (e.g., the spatial Rx filter 946) associated with the spatial filter (e.g., a spatial Tx filter) used for transmission of the PRACH signal (e.g., in the indicated PRACH occasion) the network node 904 used to determine the TA value.

The UE 902 may optionally transmit a UL message 948 to the network node 904 in response to the fourth message (Msg4) 942. In some examples, the UL message 948 may include an acknowledgement (ACK).

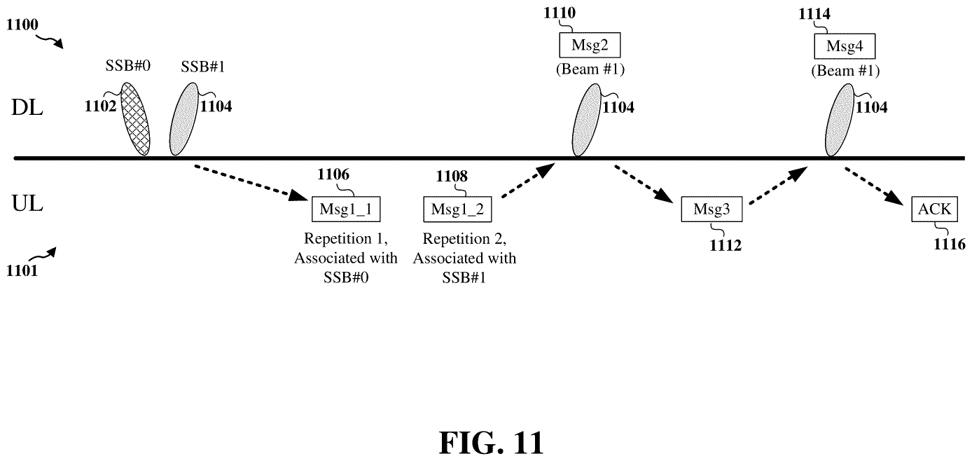

FIG. 11 is a diagram illustrating an example of a four-step RACH procedure based on multiple beams in accordance with various aspects of the disclosure. The DL communications 1100 in FIG. 11 may be performed by a network node (e.g., the network node 904) and the UL communications 1101 may be performed by a UE (e.g., the UE 902).

The network node may transmit multiple SSBs using different beams, such as a first SSB (SSB #0) using a first beam (Beam #0) 1102 and a second SSB (SSB #1) using a second beam (Beam #1) 1104. Each SSB may be mapped to one or more PRACH occasions (ROs). The mapping between SSBs and ROs (also referred to as SSB-RO mapping) may be indicated to the UE in an SIB.

The UE may select an SSB based on an RSRP measurement and may select a PRACH resource associated with the selected SSB. For example, the UE may be configured to select SSBs having a measured RSRP that is greater than or equal to a threshold. In the example of FIG. 11, the UE may determine that the first SSB (SSB #0) and the second SSB (SSB #1) each have an RSRP that exceeds a threshold.

The UE may transmit a first repetition of the initial message (e.g., Msg1_1 1106) of the four-step RACH procedure using a first spatial filter associated with the first SSB (e.g., SSB #0) in one PRACH occasion (e.g., the PRACH occasion #0 (RO #0) 704) and may transmit a second repetition of the initial message (e.g., Msg1_2 1108) of the four-step RACH procedure using a second spatial filter associated with the second SSB (e.g., SSB #1) in a different PRACH occasion (e.g., the PRACH occasion #5 (RO #5) 714). For example, the UE may transmit Msg1_1 1106 using the first beam (Beam #0) 1102 of the first SSB (SSB #0) and may transmit Msg1_2 1108 using the second beam (Beam #1) 1104 of the second SSB (SSB #1). For example, each of Msg1_1 1106 and Msg1_2 1108 may be referred to as a PRACH signal and may include the same PRACH preamble.

The network node may select the second SSB (e.g., SSB #1) to transmit the second message (Msg2) 1110 of the four-step RACH procedure. In other words, the network node may select the second beam (Beam #1) 1104 of the second SSB (e.g., SSB #1) to transmit the second message (Msg2) 1110. In one example scenario, the network node may fail to receive Msg1_1 1106 transmitted using the first beam (Beam #0) 1102 of the first SSB (SSB #0) and, therefore, may select the second SSB (e.g., SSB #1) for transmission of the second message (Msg2) 1110. In another example scenario, the network node may successfully receive both of Msg1_1 1106 transmitted using the first beam (Beam #0) 1102 of the first SSB (SSB #0) and Msg1_2 1108 transmitted using the second beam (Beam #1) 1104 of the second SSB (SSB #1), but may select the second beam (Beam #1) 1104 of the second SSB (e.g., SSB #1) for transmission of the second message (Msg2) 1110.

The network node may determine a TA value (e.g., for the UE) for transmission of a third message (Msg3) of the four-step RACH procedure based on the second repetition of the initial message (e.g., Msg1_2 1108) of the four-step RACH procedure associated with the second SSB (e.g., SSB #1). The third message (Msg3) may be a scheduled UL message.

In some examples, the UE and the network node may be configured to determine the RA-RNTI based on the PRACH occasion in which the first PRACH signal (e.g., the first transmission of Msg1 of the four-step RACH procedure) is transmitted for a given PRACH preamble. Therefore, if the UE transmits the first repetition of the initial message (e.g., Msg1_1 1106) of the four-step RACH procedure in the PRACH occasion #0 (RO #0) 704, then the UE and the network node may use the PRACH occasion #0 (RO #0) 704 to determine the RA-RNTI.

Since the network node determines the TA value using a PRACH signal received in a PRACH occasion (e.g., the PRACH occasion #5 (RO #5) 714) that is different from the PRACH occasion (e.g., the PRACH occasion #0 (RO #0) 704) used for determination of the RA-RNTI, the UE may not now which repetition of the initial message (e.g., Msg1_1 1106 or Msg1_2 1108) of the four-step RACH procedure is successfully received at the network node and is used for determination of the TA value. In this scenario, the network node may include an indication of the PRACH occasion (e.g., the PRACH occasion #5 (RO #5) 714) that enables identification of the PRACH signal (e.g., Msg1_2 1108 based on the second SSB (SSB #1)) used for determination of the TA value.

The UE may transmit the third message (Msg3) of the four-step RACH procedure based on the TA value and the spatial filter used for transmission of the PRACH signal (e.g., Msg1_2 1108 based on the second SSB (SSB #1)) in the PRACH occasion (e.g., the PRACH occasion #5 (RO #5) 714) indicated in Msg2 1110. For example, the spatial filter may represent the second beam (Beam #1) 1104 of the second SSB (SSB #1).

The network node may transmit a contention resolution message (e.g., the fourth message (Msg4) 1114 of the four-step RACH procedure) in response to the third message (Msg3) 1112 of the four-step RACH procedure. For example, the UE may receive the fourth message (Msg4) 1114 based on a spatial filter (e.g., a spatial Rx filter) associated with the spatial filter (e.g., a spatial Tx filter) used for transmission of the PRACH signal (e.g., in the indicated PRACH occasion) the network node used to determine the TA value. The UE 902 may optionally transmit an ACK message 1116 to the network node in response to the fourth message (Msg4) 1114.

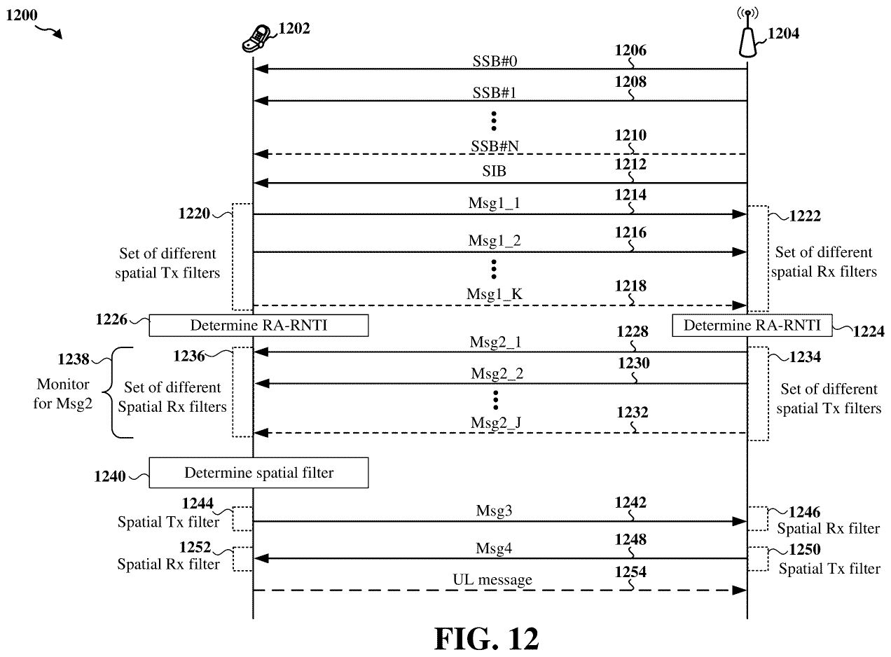

FIG. 12 is a signal flow diagram 1200 in accordance with various aspects of the disclosure. The signal flow diagram 1200 includes a UE 1202 and a network node 1204.

The network node 1204 may transmit multiple SSBs using spatial domain beam forming. For example, with reference to FIG. 12, the network node 1204 may transmit a first SSB (SSB #0) 1206 using a first beam (e.g., Beam #0) in a first time period, a second SSB (SSB #1) 1208 using a second beam (e.g., Beam #1) in a second time period, and so on up to an Nth SSB (SSB #N) 1210 using an Nth beam (e.g., Beam #N) in an Nth time period, where N is an integer in the range 0 to M−1, and M represents the total number of transmitted SSBs. For example, each beam (e.g., Beam #0, Beam #1, Beam #N) of the multiple SSBs may be associated with a different direction and/or size. In some examples, each of the multiple SSBs (e.g., the first SSB (SSB #0) 1206, the second SSB (SSB #1) 1208, the Nth SSB (SSB #N) 1210) may carry the same system information.

Each of the multiple SSBs (e.g., the first SSB (SSB #0) 1206, the second SSB (SSB #1) 1208, the Nth SSB (SSB #N) 1210) may be associated with a unique index. For example, the first SSB 1206 may have an index 0, the second SSB 1208 may have an index 1, and the Nth SSB 1210 may have an index N.

The UE 1202 may receive one or more SIBs, such as SIB 1212, from the network node 1204. For example, the SIB 1212 may be a SIB1. The SIB1 may include RACH configuration information. The UE 1202 may receive the SIB 1212 using PDSCH resources indicated by the PDCCH.

The UE 1202 may transmit multiple PRACH signals using a set of different spatial filters (e.g., a set of different spatial Tx filters 1220), where each of the multiple PRACH signals is transmitted during a different PRACH occasion. Each PRACH signal may be an initial message (e.g., Msg1) of a four-step PRACH procedure and may include a PRACH preamble as described herein. For example, the UE 1202 may transmit a first PRACH signal (e.g., Msg1_1 1214) including a PRACH preamble, a second PRACH signal (e.g., Msg1_2 1216) including the PRACH preamble, and so on up to a Kth PRACH signal (Msg1_K 1218) including the PRACH preamble, where K is a positive integer, and where K>2. The network node 1204 may receive the multiple PRACH signals using a set of different spatial filters (e.g., a set of different spatial Rx filters 1222).

Example transmissions of two PRACH signals by the UE 1202 using two different spatial filters (e.g., a first spatial filter and a second spatial filter) during different PRACH occasions will now be described with reference to FIG. 10. For example, with reference to FIG. 10, the UE 1202 may transmit Msg1_1 1214 in PRACH occasion #0 (RO #0) 704 using a first spatial filter associated with SSB #0 720, and Msg1_2 1216 in PRACH occasion #5 (RO #5) 714 using a second spatial filter associated with SSB #1 730. In some examples, Msg1_2 1216 may be a repetition of Msg1_1 1214. In these examples, Msg1_1 1214 and Msg1_2 1216 may each include the same PRACH preamble.

Referring back to FIG. 12, at 1224, the network node 1204 may determine an RA-RNTI. In some examples, the network node 1204 may determine the RA-RNTI based on equation (1) described herein. At 1226, the UE 1202 may also determine the RA-RNTI. In some examples, the UE 1202 may determine the RA-RNTI based on equation (1) described herein. In some aspects, the UE 1202 may determine different RA-RNTIs based on different PRACH occasions associated with the multiple PRACH signals (e.g., Msg1_1 1214, Msg1_2 1216, Msg1_K 1218). In these aspects, and network node 1204 may also determine different RA-RNTIs based on different PRACH occasions associated with the multiple PRACH signals (e.g., Msg1_1 1214, Msg1_2 1216, Msg1_K 1218).

The network node 1204 may transmit multiple repetitions of the second message (Msg2) of the four-step RACH procedure. For example, the network node 1204 may transmit a first repetition of the second message (Msg2_1) 1228, a second repetition of the second message (Msg2_2) 1230, and so on up to a Jth repetition of the second message (Msg2_J) 1232, where J is an integer. In some aspects, the network node 1204 may transmit the multiple repetitions of the second message (Msg2) (e.g., Msg2_1 1228, Msg2_2 1230, Msg2_J 1232) using a set of different spatial filters (e.g., a set of different spatial Tx filters 1234). The multiple repetitions of the second message (Msg2) of the four-step RACH procedure may enhance coverage for the UE 1202 when attempting to receive the second message (Msg2) of the four-step RACH procedure.

The network node 1204 may use the PDCCH for scheduling and the PDSCH for transmission of each of the multiple repetitions of the second message (Msg2) of the four-step RACH procedure. Each of the multiple repetitions of the second message (Msg2) of the four-step RACH procedure may include a TA value, a UL grant for transmission of a scheduled UL message (e.g., message 3 (Msg3) 1234) by the UE 1202 using the PUSCH, and a TC-RNTI. The network node 1204 may scramble the PDCCH for scheduling the transmission of a repetition of the second message (Msg2) based on the RA-RNTI.

In some aspects, the RA-RNTI for each of the multiple repetitions of the second message (Msg2) of the four-step RACH procedure may be the same. In these aspects, the RA-RNTI may be referred to as a common RA-RNTI. For example, the network node 1204 may use the common RA-RNTI for each of the multiple repetitions of the second message (Msg2) of the four-step RACH procedure (e.g., Msg2_1 1228, Msg2_2 1230, Msg2_J 1232) transmitted with different spatial filters (e.g., the set of different spatial Tx filters 1234). For example, the network node 1204 may determine the common RA-RNTI based on one of the PRACH occasions used for the multiple PRACH signal transmissions (e.g., the multiple PRACH signal transmissions including Msg1_1 1214, Msg1_2 1216, Msg1_K 1218).

In some aspects, the RA-RNTI for each of the multiple repetitions of the second message (Msg2) of the four-step RACH procedure may be different. For example, the network node 1204 may use a different RA-RNTI for each of the multiple repetitions of the second message (Msg2) of the four-step RACH procedure (e.g., Msg2_1 1228, Msg2_2 1230, Msg2_J 1232) transmitted in different spatial filters (e.g., the set of different spatial Tx filters 1234). The network node 1204 may determine each RA-RNTI for each respective repetition of the second message (Msg2) of the four-step RACH procedure based on one of the PRACH occasions associated with a DL reference signal (e.g., an SSB, such as SSB #0 or SSB #1) for transmission of a repetition of the second message (Msg2) of the four-step RACH procedure.

At 1238, the UE 1202 monitors the PDCCH associated with a random access response message (e.g., a second message (Msg2) of the four-step RACH procedure) based on a common RA-RNTI or different RA-RNTIs, and a set of different spatial filters (e.g., a set of different spatial Rx filters 1236) until the random access response message is successfully received (e.g., until at least one of the Msg2_1 1228, Msg2_2 1230, Msg2_J 1232 is successfully received). For example, with reference to FIG. 12, the set of different spatial Rx filters 1236 may be associated with spatial Rx filters applied at the UE 1202 to receive DL reference signals (e.g., SSBs, such as SSB #0 1206, SSB #1 1208, SSB #N 1210) for the multiple PRACH signal transmissions (e.g., the multiple PRACH signal transmissions including Msg1_1 1214, Msg1_2 1216, Msg1_K 1218). The UE 1202 may cease monitoring the PDCCH associated with the random access response message if at least one repetition of the random access response message (e.g., Msg2_1 1224, Msg2_2 1226, Msg2_J 1228) is successfully received.

At 1240, the UE 1202 may determine a spatial filter (e.g., a spatial Tx filter 1244) for transmission of the third message (Msg3) of the four-step RACH procedure using the approaches described herein with reference to 934 in FIG. 9. The third message (Msg3) of the four-step RACH procedure may be a scheduled UL message. The UE 1202 may transmit the third message (Msg3) 1242 of the four-step RACH procedure based on the spatial filter determined at 1240. The network node 1204 may receive the third message (Msg3) 1242 using a spatial filter (e.g., a spatial Rx filter 1246).

The network node 1204 may transmit a contention resolution message (e.g., the fourth message (Msg4) 1248 of the four-step RACH procedure) in response to the third message (Msg3) 1242 using a spatial filter (e.g., a spatial Tx filter 1250).

The UE 1202 may receive the contention resolution message (e.g., the fourth message (Msg4) 1248 of the four-step RACH procedure) based on a spatial filter (e.g., a spatial Rx filter 1252) associated with the spatial filter (e.g., a spatial Rx filter in the set of different spatial Rx filters 1236) used for reception of the successfully received repetition of the random access response message (e.g., one of Msg2_1 1224, Msg2_2 1226, Msg2_J 1228).

The UE 1202 may optionally transmit a UL message 1254 to the network node 1204 in response to the fourth message (Msg4) 1248. In some examples, the UL message 1238 may include an acknowledgement (ACK).

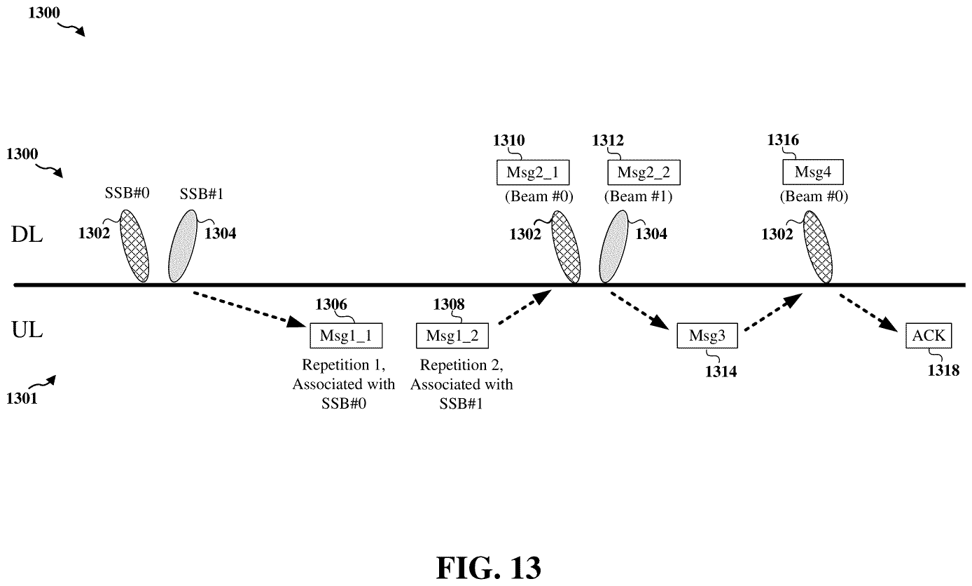

FIG. 13 is a diagram illustrating an example of a four-step RACH procedure based on multiple beams in accordance with various aspects of the disclosure. The DL communications 1300 in FIG. 13 may be performed by a network node (e.g., the network node 1204) and the UL communications 1301 may be performed by a UE (e.g., the UE 1202).

The network node may transmit multiple SSBs using different beams, such as a first SSB (SSB #0) using a first beam (Beam #0) 1302 and a second SSB (SSB #1) using a second beam (Beam #1) 1304. Each SSB may be mapped to one or more PRACH occasions (ROs). The mapping between SSBs and ROs (also referred to as SSB-RO mapping) may be indicated to the UE in an SIB.

The UE may select an SSB based on an RSRP measurement and may select a PRACH resource associated with the selected SSB. For example, the UE may be configured to select SSBs having a measured RSRP that is greater than or equal to a threshold. In the example of FIG. 13, the UE may determine that the first SSB (SSB #0) and the second SSB (SSB #1) each have an RSRP that exceeds a threshold.

The UE may transmit a first repetition of the initial message (e.g., Msg1_1 1306) of the four-step RACH procedure using a first spatial filter associated with the first SSB (e.g., SSB #0) in one PRACH occasion (e.g., the PRACH occasion #0 (RO #0) 704) and may transmit a second repetition of the initial message (e.g., Msg1_2 1308) of the four-step RACH procedure using a second spatial filter associated with the second SSB (e.g., SSB #1) in a different PRACH occasion (e.g., the PRACH occasion #5 (RO #5) 714). For example, the UE may transmit Msg1_1 1306 using the first beam (Beam #0) 1302 of the first SSB (SSB #0) and may transmit Msg1_2 1308 using the second beam (Beam #1) 1304 of the second SSB (SSB #1). For example, each of Msg1_1 1306 and Msg1_2 1308 may be referred to as a PRACH signal and may include the same PRACH preamble.

The network node may transmit a first repetition of the second message (Msg2_1) 1310 of the four-step RACH procedure using the first beam (Beam #0) 1302 of the first SSB (SSB #0) and a second repetition of the second message (Msg2_2) 1312 of the four-step RACH procedure using the second beam (Beam #1) 1304 of the second SSB (SSB #1). In some scenarios, the network node may transmit one of the first repetition of the second message (Msg2_1) 1310 and the second repetition of the second message (Msg2_2) 1312.

In some examples, the UE and the network node may be configured to determine the RA-RNTI based on the PRACH occasion in which the first PRACH signal is transmitted for a given PRACH preamble. Therefore, if the UE transmits the first repetition of the initial message (e.g., Msg1_1 1306) of the four-step RACH procedure in the PRACH occasion #0 (RO #0) 704, then the UE and the network node may use the PRACH occasion #0 (RO #0) 704 to determine the RA-RNTI. In some aspects, the RA-RNTI may be a common RA-RNTI that applies to both repetitions (e.g., Msg2_1 1310 and Msg2_2 1312) of the second message of the four-step RACH procedure.

In some examples, the UE and the network node may be configured to determine a different RA-RNTI for each repetition (e.g., Msg2_1 1310 and Msg2_2 1312) of the second message (Msg2) of the four-step RACH procedure. For example, the UE may determine a first RA-RNTI based on the PRACH occasion in which the first PRACH signal is transmitted for a given PRACH preamble and a second RA-RNTI based on the PRACH occasion in which the second PRACH signal is transmitted for a given PRACH preamble. Therefore, if the UE transmits the first repetition of the initial message (e.g., Msg1_1 1306) of the four-step RACH procedure in the PRACH occasion #0 (RO #0) 704 and transmits the second repetition of the initial message (e.g., Msg1_2 1308) of the four-step RACH procedure in the PRACH occasion #5 (RO #5) 714, then the UE and the network node may use the PRACH occasion #0 (RO #0) 704 to determine the RA-RNTI for the first repetition of the second message (e.g., Msg2_1 1310) of the four-step RACH procedure and may use the PRACH occasion #5 (RO #5) 714 to determine the RA-RNTI for the second repetition of the second message (e.g., Msg2_2 1312) of the four-step RACH procedure.

The UE may monitor the PDCCH associated with a random access response message (e.g., a second message (Msg2) of the four-step RACH procedure) based on a common RA-RNTI or different RA-RNTIs, and a set of different spatial Rx filters until Msg2_1 1310 or Msg2_2 1312 is successfully received. For example, with reference to FIG. 13, the set of different spatial Rx filters may be associated with spatial Rx filters applied at the UE to receive the first SSB #0 and the second SSB #1 for the multiple PRACH signal transmissions (e.g., the multiple PRACH signal transmissions including Msg1_1 1306 and Msg1_2 1308.

The UE may cease monitoring the PDCCH associated with the random access response message if at least one repetition of the random access response message (e.g., Msg2_1 1310 or Msg2_2 1312) is successfully received. For example, if the UE successfully receives Msg2_1 1310 associated with Beam #0 1302, then UE stops monitoring the PDCCH associated with the random access response message (e.g., stops attempting to receive the second message (Msg2) of the four-step RACH procedure.

In the example of FIG. 13, the UE may transmit the third message (Msg3) of the four-step RACH procedure (e.g., Msg3 1314) based on a TA value (e.g., a TA value included in Msg2_1 1310 and Msg2_2 1312) and the spatial filter used for transmission of the PRACH signal (e.g., Msg1_2 1308 using Beam #0 of the first SSB (SSB #0)) in the in the first PRACH occasion (e.g., the PRACH occasion #0 (RO #0) 704). For example, the spatial filter may represent the first beam (Beam #0) 1302 of the first SSB (SSB #0).

The network node may transmit a contention resolution message (e.g., the fourth message (Msg4) 1316 of the four-step RACH procedure) in response to the third message (Msg3) 1314. The UE may receive the contention resolution message (e.g., the fourth message (Msg4) 1316 of the four-step RACH procedure) and may optionally transmit a UL message 1318 to the network node in response to the fourth message (Msg4) 1316. In some examples, the UL message 1318 may include an acknowledgement (ACK).

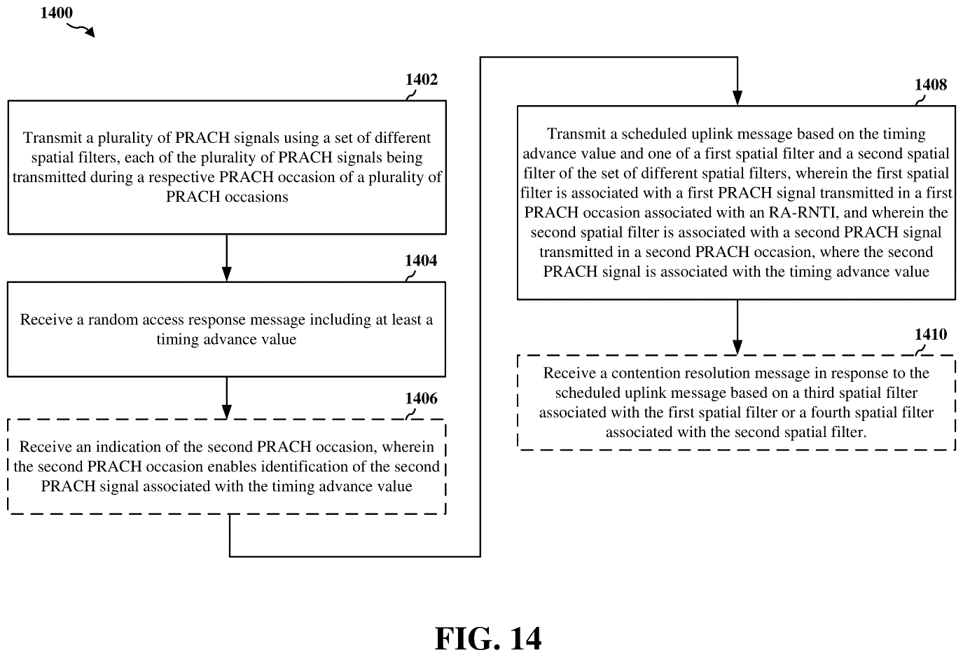

FIG. 14 is a flowchart 1400 of a method of wireless communication. The method may be performed by a UE (e.g., the UE 104, 902, 1202; the apparatus 1502/1502′; the processing system 1614, which may include the memory 360 and which may be the entire UE or a component of the UE, such as the TX processor 368, the RX processor 356, and/or the controller/processor 359). It should be understood that blocks indicated with dashed lines in FIG. 14 represent optional blocks.

At 1402, the UE transmits a plurality of PRACH signals using a set of different spatial filters, each of the plurality of PRACH signals being transmitted during a respective PRACH occasion of a plurality of PRACH occasions. For example, with reference to FIG. 9, the UE 902 may transmit a first PRACH signal (e.g., Msg1_1 914) including a PRACH preamble, a second PRACH signal (e.g., Msg1_2 916) including the PRACH preamble, and so on up to a Kth PRACH signal (Msg1_K 918) including the PRACH preamble, where K is a positive integer, and where K>2. The UE may transmit the multiple PRACH signals using the set of different spatial Tx filters 920. In some examples, the UE 902 may transmit two PRACH signals using the set of different spatial filters.

At 1404, the UE receives a random access response message including at least a timing advance value. In some aspects, the UE receives the random access response message (e.g., the second message (Msg2) 928 of the four-step RACH procedure) based on a third spatial filter (e.g., the spatial Rx filter 932 in FIG. 9) associated with the first spatial filter.

In some aspects, the random access response message is included in a set of random access response messages. For example, with reference to FIG. 12, the set of random access response messages may include the first repetition of the second message (Msg2_1) 1228, a second repetition of the second message (Msg2_2) 1230, and so on up to a Jth repetition of the second message (Msg2_J) 1232. The set of random access response messages are based on a second set of different spatial filters (e.g., the set of different spatial Tx filters 1234) associated with the set of different spatial filters (e.g., the set of different spatial Tx filters 1220 or the set of different spatial Rx filters 1222). In these aspects, the UE receives the random access response message (e.g., at least one Msg2_1 1228, Msg2_2 1230, Msg2_J 1232) based on the RA-RNTI. One or more downlink control channels (e.g., PDCCH) associated with the set of random access response messages are scrambled based on the RA-RNTI.

In some aspects, the random access response message is included in a set of random access response messages. For example, with reference to FIG. 12, the set of random access response messages may include the first repetition of the second message (Msg2_1) 1228, a second repetition of the second message (Msg2_2) 1230, and so on up to a Jth repetition of the second message (Msg2_J) 1232. The set of random access response messages are based on a second set of different spatial filters (e.g., the set of different spatial Tx filters 1234) associated with the set of different spatial filters (e.g., the set of different spatial Tx filters 1220 or the set of different spatial Rx filters 1222). In these aspects, the UE receives the random access response message (e.g., at least one Msg2_1 1228, Msg2_2 1230, Msg2_J 1232) by determining different RA-RNTIs based on different PRACH occasions associated with the plurality of PRACH signals, and monitoring (e.g., at 1238 in FIG. 12) a control channel (e.g., PDCCH) associated with the random access response message based on the different RA-RNTIs and a third set of different spatial filters (e.g., the set of different spatial Rx filters 1236) until the random access response message is successfully received.

At 1406, the UE optionally receives an indication of the second PRACH occasion, wherein the second PRACH occasion enables identification of the second PRACH signal associated with the timing advance value. In some aspects, the indication of the second PRACH occasion is included in the random access response message or in downlink control information. In some aspects, the indication includes at least one of an index of the second PRACH occasion, time-frequency information of the second PRACH occasion, or information relative to a reference PRACH occasion.

At 1408, the UE transmits a scheduled uplink message based on the timing advance value and one of a first spatial filter and a second spatial filter of the set of different spatial filters, wherein the first spatial filter is associated with a first PRACH signal transmitted in a first PRACH occasion associated with an RA-RNTI, and wherein the second spatial filter is associated with a second PRACH signal transmitted in a second PRACH occasion, where the second PRACH signal is associated with the timing advance value. In some aspects, the UE transmits the scheduled uplink message based on the timing advance value and the second spatial filter when the indication of the second PRACH occasion is received. In some aspects, the UE transmits the scheduled uplink message based on the timing advance value and the first spatial filter when an indication of the second PRACH occasion is not provided to the UE.

At 1410, the UE receives a contention resolution message in response to the scheduled uplink message based on a third spatial filter associated with the first spatial filter or a fourth spatial filter associated with the second spatial filter.

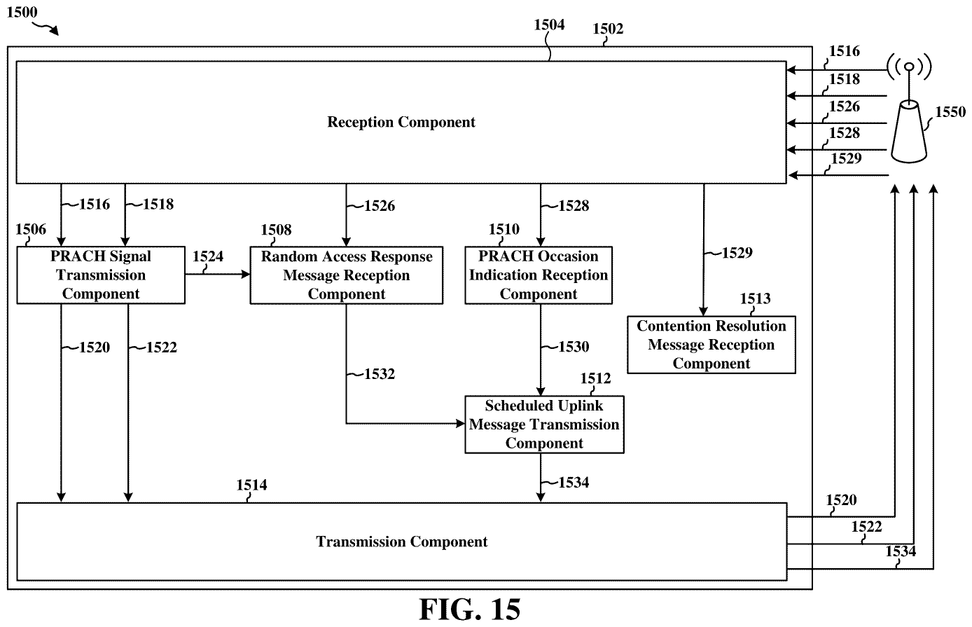

FIG. 15 is a conceptual data flow diagram 1500 illustrating the data flow between different means/components in an example apparatus 1502. The apparatus may be a UE.

The apparatus includes a PRACH signal transmission component 1506 that transmits a plurality of PRACH signals (e.g., PRACH signals 1520, 1522 transmitted to network node 1550) using a set of different spatial filters, each of the plurality of PRACH signals being transmitted during a respective PRACH occasion of a plurality of PRACH occasions. The set of different spatial filters may be associated with the beams of different SSBs (e.g., a first SSB 1516, a second SSB 1518).

The apparatus includes a random access response message reception component 1508 that receives a random access response message (e.g., random access response message 1526) including at least a timing advance value. The random access response message reception component 1508 may receive information 1524 indicating transmitted PRACH signals (e.g., PRACH signals 1520, 1522) and their corresponding PRACH occasions and spatial filters.

The apparatus includes a PRACH occasion indication reception component 1510 that receives an indication 1528 of the second PRACH occasion, wherein the second PRACH occasion enables identification of the second PRACH signal associated with the timing advance value.

The apparatus includes a scheduled uplink message transmission component 1512 that transmits a scheduled uplink message 1534 based on the timing advance value and one of a first spatial filter and a second spatial filter of the set of different spatial filters, wherein the first spatial filter is associated with a first PRACH signal transmitted in a first PRACH occasion associated with a RA-RNTI, and wherein the second spatial filter is associated with a second PRACH signal transmitted in a second PRACH occasion, where the second PRACH signal is associated with the timing advance value.

The scheduled uplink message transmission component 1512 may receive a message 1532 including at least the timing advance value. The scheduled uplink message transmission component 1512 may receive a message 1530 including the indication 1528 of the second PRACH occasion.

The apparatus includes a contention resolution message reception component 1513 that receives a contention resolution message 1529 in response to the scheduled uplink message based on a third spatial filter associated with the first spatial filter or a fourth spatial filter associated with the second spatial filter.

The apparatus may include additional components that perform each of the blocks of the algorithm in the aforementioned flowchart of FIG. 14. As such, each block in the aforementioned flowchart of FIG. 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

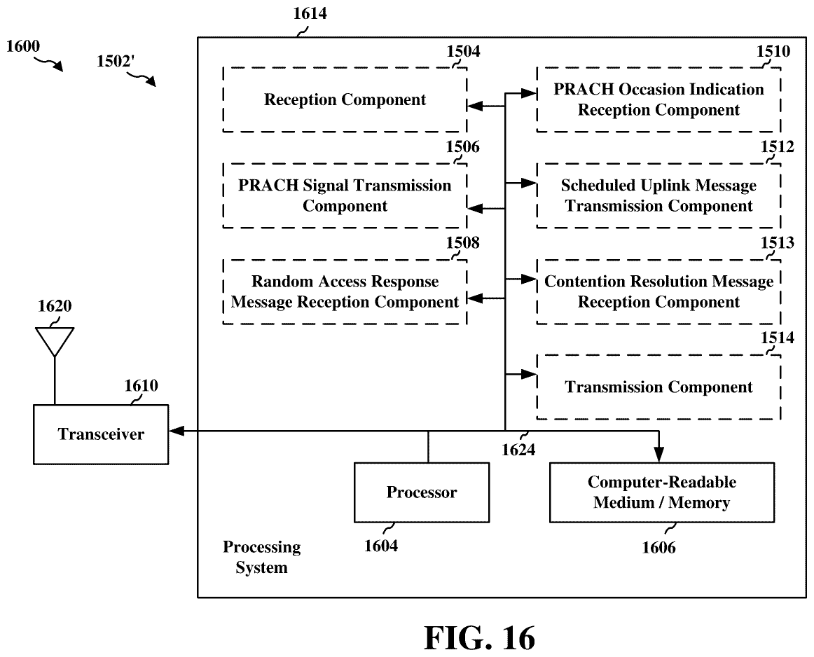

FIG. 16 is a diagram 1600 illustrating an example of a hardware implementation for an apparatus 1502′ employing a processing system 1614. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware components, represented by the processor 1604, the components 1504, 1506, 1508, 1510, 1512, 1513, 1514, and the computer-readable medium/memory 1606. The bus 1624 may also link various other circuits such as timing sources, peripherals, voltage regulators, and power management circuits, which are well known in the art, and therefore, will not be described any further.

The processing system 1614 may be coupled to a transceiver 1610. The transceiver 1610 is coupled to one or more antennas 1620. The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception component 1504. In addition, the transceiver 1610 receives information from the processing system 1614, specifically the transmission component 1514, and based on the received information, generates a signal to be applied to the one or more antennas 1620. The processing system 1614 includes a processor 1604 coupled to a computer-readable medium/memory 1606. The processor 1604 is responsible for general processing, including the execution of software stored on the computer-readable medium/memory 1606. The software, when executed by the processor 1604, causes the processing system 1614 to perform the various functions described supra for any particular apparatus. The computer-readable medium/memory 1606 may also be used for storing data that is manipulated by the processor 1604 when executing software. The processing system 1614 further includes at least one of the components 1504, 1506, 1508, 1510, 1512, 1513, 1514. The components may be software components running in the processor 1604, resident/stored in the computer readable medium/memory 1606, one or more hardware components coupled to the processor 1604, or some combination thereof. The processing system 1614 may be a component of the UE 350 and may include the memory 360 and/or at least one of the TX processor 368, the RX processor 356, and the controller/processor 359. Alternatively, the processing system 1614 may be the entire UE (e.g., see 350 of FIG. 3).

In one configuration, the apparatus 1502/1502′ for wireless communication includes means for transmitting a plurality of PRACH signals using a set of different spatial filters, each of the plurality of PRACH signals being transmitted during a respective PRACH occasion of a plurality of PRACH occasions, means for receiving a random access response message including at least a timing advance value, means for receiving an indication of the second PRACH occasion, wherein the second PRACH occasion enables identification of the second PRACH signal associated with the timing advance value, means for transmitting a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value, and means for receiving a contention resolution message in response to the scheduled uplink message based on a third spatial filter associated with the first spatial filter or a fourth spatial filter associated with the second spatial filter.

The aforementioned means may be one or more of the aforementioned components of the apparatus 1502 and/or the processing system 1614 of the apparatus 1502′ configured to perform the functions recited by the aforementioned means. As described supra, the processing system 1614 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

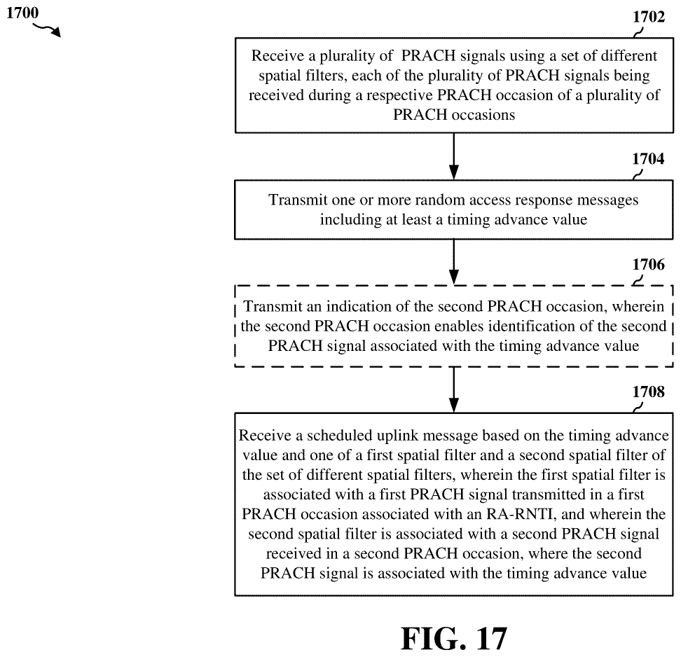

FIG. 17 is a flowchart 1700 of a method of wireless communication. The method may be performed by a network node (e.g., the base station 102, network node 904, 1204; the apparatus 1802/1802′; the processing system 1914, which may include the memory 376 and which may be the entire network node or a component of the network node, such as the TX processor 316, the RX processor 370, and/or the controller/processor 375). It should be understood that blocks indicated with dashed lines in FIG. 17 represent optional blocks.

At 1702, the network node receives a plurality of PRACH signals using a set of different spatial filters, each of the plurality of PRACH signals being received during a respective PRACH occasion of a plurality of PRACH occasions.

At 1704, the network node transmits one or more random access response messages including at least a timing advance value. In some aspects, the network node transmits the one or more random access response messages based on a third spatial filter associated with the first spatial filter.

In some aspects, the one or more random access response messages is transmitted based on a second set of different spatial filters associated with the set of different spatial filters. In these aspects, the network node transmits the one or more random access response messages based on the RA-RNTI, where one or more downlink control channels associated with the one or more random access response messages are scrambled based on the RA-RNTI.

In some aspects, the one or more random access response messages is transmitted based on a second set of different spatial filters associated with the set of different spatial filters. In these aspects, the network node transmits the one or more random access response messages by determining different RA-RNTIs based on different PRACH occasions associated with the plurality of PRACH signals and transmitting each of the one or more random access response messages based on the different RA-RNTIs and the second set of different spatial filters.

At 1706, the network node transmits an indication of the second PRACH occasion, wherein the second PRACH occasion enables identification of the second PRACH signal associated with the timing advance value. In some aspects, the indication of the second PRACH occasion is included in the random access response message or in downlink control information. In some aspects, the indication includes at least one of an index of the second PRACH occasion, time-frequency information of the second PRACH occasion, or information relative to a reference PRACH occasion.

At 1708, the network node receives a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal received in a second PRACH occasion, where the second PRACH signal is associated with the timing advance value.

In some aspects, the network node receives the scheduled uplink message based on the timing advance value and the second spatial filter when the indication of the second PRACH occasion is transmitted. In some aspects, the network node receives the scheduled uplink message based on the timing advance value and the first spatial filter when an indication of the second PRACH occasion is not transmitted.

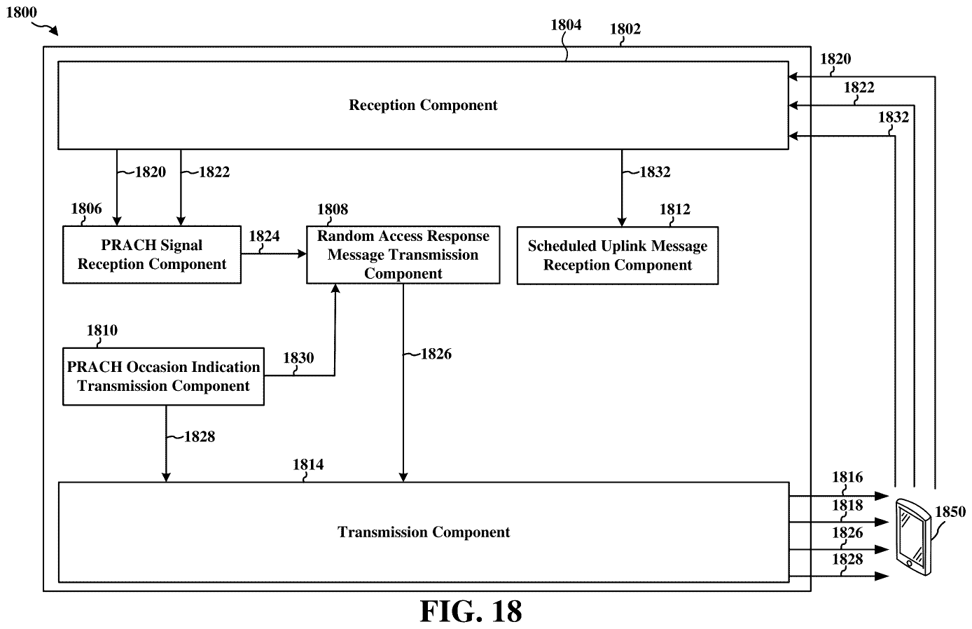

FIG. 18 is a conceptual data flow diagram 1800 illustrating the data flow between different means/components in an example apparatus 1802. The apparatus may be a network node (e.g., a base station). The apparatus includes a PRACH signal reception component 1806 that receives a plurality of PRACH signals (e.g., PRACH signals 1820, 1822 from a UE 1850) using a set of different spatial filters, each of the plurality of PRACH signals being received during a respective PRACH occasion of a plurality of PRACH occasions. The set of different spatial filters may be associated with the beams of different SSBs (e.g., a first SSB 1816, a second SSB 1818).

The apparatus includes a random access response message transmission component 1808 that transmits one or more random access response messages (e.g., random access response message 1826) including at least a timing advance value.

The apparatus includes a PRACH occasion indication transmission component 1810 that transmits an indication 1828 of the second PRACH occasion, wherein the second PRACH occasion enables identification of the second PRACH signal associated with the timing advance value. In some aspects, the PRACH occasion indication transmission component 1810 may provide the indication of the second PRACH occasion to the random access response message transmission component 1808 via a message 1830.

The apparatus includes a scheduled uplink message reception component 1812 that receives a scheduled uplink message 1832 based on the timing advance value and one of a first spatial filter and a second spatial filter of the set of different spatial filters, wherein the first spatial filter is associated with a first PRACH signal transmitted in a first PRACH occasion associated with an RA-RNTI, and wherein the second spatial filter is associated with a second PRACH signal received in a second PRACH occasion, where the second PRACH signal is associated with the timing advance value.

The apparatus may include additional components that perform each of the blocks of the algorithm in the aforementioned flowchart of FIG. 17. As such, each block in the aforementioned flowchart of FIG. 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

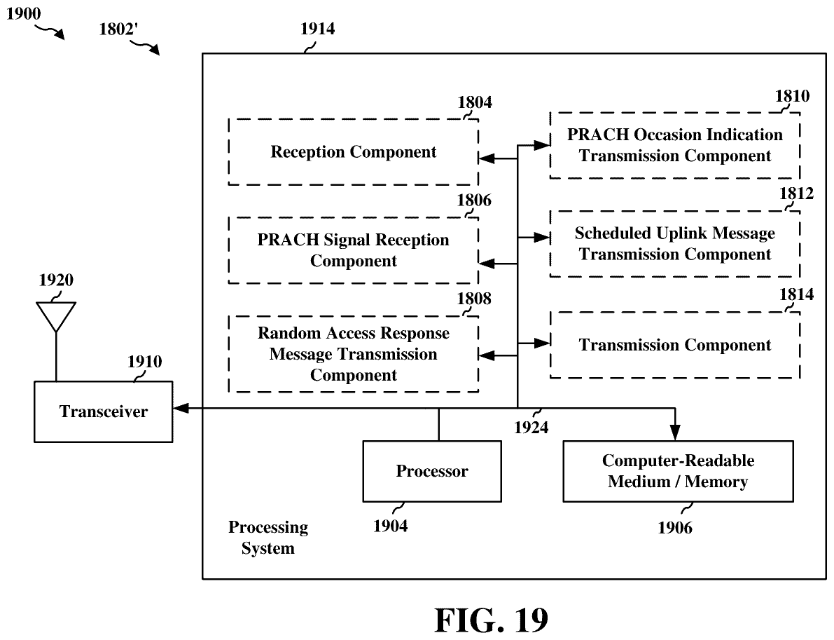

FIG. 19 is a diagram 1900 illustrating an example of a hardware implementation for an apparatus 1802′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware components, represented by the processor 1904, the components 1804, 1806, 1808, 1810, 1812, 1814 and the computer-readable medium/memory 1906. The bus 1924 may also link various other circuits such as timing sources, peripherals, voltage regulators, and power management circuits, which are well known in the art, and therefore, will not be described any further.

The processing system 1914 may be coupled to a transceiver 1910. The transceiver 1910 is coupled to one or more antennas 1920. The transceiver 1910 provides a means for communicating with various other apparatus over a transmission medium. The transceiver 1910 receives a signal from the one or more antennas 1920, extracts information from the received signal, and provides the extracted information to the processing system 1914, specifically the reception component 1804. In addition, the transceiver 1910 receives information from the processing system 1914, specifically the transmission component 1814, and based on the received information, generates a signal to be applied to the one or more antennas 1920. The processing system 1914 includes a processor 1904 coupled to a computer-readable medium/memory 1906. The processor 1904 is responsible for general processing, including the execution of software stored on the computer-readable medium/memory 1906. The software, when executed by the processor 1904, causes the processing system 1914 to perform the various functions described supra for any particular apparatus. The computer-readable medium/memory 1906 may also be used for storing data that is manipulated by the processor 1904 when executing software. The processing system 1914 further includes at least one of the components 1804, 1806, 1808, 1810, 1812, 1814. The components may be software components running in the processor 1904, resident/stored in the computer readable medium/memory 1906, one or more hardware components coupled to the processor 1904, or some combination thereof. The processing system 1914 may be a component of the base station 310 and may include the memory 376 and/or at least one of the TX processor 316, the RX processor 370, and the controller/processor 375. Alternatively, the processing system 1914 may be the entire base station (e.g., see 310 of FIG. 3).

In one configuration, the apparatus 1802/1802′ for wireless communication includes means for receiving a plurality of PRACH signals using a set of different spatial filters, each of the plurality of PRACH signals being received during a respective PRACH occasion of a plurality of PRACH occasions, means for transmitting one or more random access response messages including at least a timing advance value, means for transmitting an indication of the second PRACH occasion, wherein the second PRACH occasion enables identification of the second PRACH signal associated with the timing advance value, means for receiving a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal received in a second PRACH occasion, where the second PRACH signal is associated with the timing advance value.

The aforementioned means may be one or more of the aforementioned components of the apparatus 1802 and/or the processing system 1914 of the apparatus 1802′ configured to perform the functions recited by the aforementioned means. As described supra, the processing system 1914 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The aspects described herein may improve the performance of a UE when performing a RACH procedure (e.g., a four-step RACH procedure) when the UE uses different spatial (Tx) filters (e.g., different beams) to transmit multiple PRACH signals (e.g., multiple repetitions of Msg1 of the four-step RACH procedure) in a multi-beam wireless communication system. The aspects described herein may enable the UE to use a spatial (Tx) filter associated with an indicated TA value to improve message transmissions and/or receptions and enhance coverage during a RACH procedure.

The following provides an overview of aspects of the present disclosure:

Aspect 1: An apparatus for wireless communication, comprising: a memory; and at least one processor coupled to the memory and configured to: transmit a plurality of physical random access channel (PRACH) signals using a set of different spatial filters, each of the plurality of PRACH signals being transmitted during a respective PRACH occasion of a plurality of PRACH occasions; receive a random access response message including at least a timing advance value; and transmit a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value.

Aspect 2: The apparatus of aspect 1, wherein the at least one processor is further configured to: receive an indication of the second PRACH occasion, wherein the second PRACH occasion enables identification of the second PRACH signal associated with the timing advance value.

Aspect 3: The apparatus of aspect 1or 2, wherein the indication of the second PRACH occasion is included in the random access response message or in downlink control information.

Aspect 4: The apparatus of any of aspects 1 through 3, wherein the indication includes at least one of an index of the second PRACH occasion, time-frequency information of the second PRACH occasion, or information relative to a reference PRACH occasion.

Aspect 5: The apparatus of any of aspects 1 through 4, wherein the at least one processor configured to transmit the scheduled uplink message based on the timing advance value and one of the first spatial filter or the second spatial filter of the set of different spatial filters is further configured to: transmit the scheduled uplink message based on the timing advance value and the second spatial filter when the indication of the second PRACH occasion is received.

Aspect 6: The apparatus of any of aspects 1 through 5, wherein the at least one processor configured to transmit the scheduled uplink message based on the timing advance value and one of the first spatial filter and the second spatial filter of the set of different spatial filters is further configured to: transmit the scheduled uplink message based on the timing advance value and the first spatial filter when an indication of the second PRACH occasion is not provided to the apparatus.

Aspect 7: The apparatus of any of aspects 1 through 6, wherein the at least one processor configured to receive the random access response message is further configured to: receive the random access response message based on a third spatial filter associated with the first spatial filter.

Aspect 8: The apparatus of any of aspects 1 through 7, wherein the at least one processor is further configured to: receive a contention resolution message in response to the scheduled uplink message based on a third spatial filter associated with the first spatial filter or a fourth spatial filter associated with the second spatial filter.

Aspect 9: The apparatus of any of aspects 1 through 8, wherein the random access response message is included in a set of random access response messages, wherein the set of random access response messages are based on a second set of different spatial filters associated with the set of different spatial filters, wherein the at least one processor configured to receive the random access response message including at least the timing advance value is further configured to: receive the random access response message based on the RA-RNTI, wherein one or more downlink control channels associated with the set of random access response messages are scrambled based on the RA-RNTI.

Aspect 10: The apparatus of any of aspects 1 through 9, wherein the random access response message is included in a set of random access response messages, wherein the set of random access response messages are based on a second set of different spatial filters associated with the set of different spatial filters, wherein the at least one processor configured to receive the random access response message including at least the timing advance value is further configured to: determine different RA-RNTIs based on different PRACH occasions associated with the plurality of PRACH signals; and monitor a control channel associated with the random access response message based on the different RA-RNTIs and a third set of different spatial filters until the random access response message is successfully received.

Aspect 11: A method of wireless communication of a user equipment (UE), comprising: transmitting a plurality of physical random access channel (PRACH) signals using a set of different spatial filters, each of the plurality of PRACH signals being transmitted during a respective PRACH occasion of a plurality of PRACH occasions; receiving a random access response message including at least a timing advance value; and transmitting a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value.

Aspect 12: The method of aspect 11, further comprising: receiving an indication of the second PRACH occasion, wherein the second PRACH occasion enables identification of the second PRACH signal associated with the timing advance value.

Aspect 13: The method of aspect 11 or 12, wherein the indication of the second PRACH occasion is included in the random access response message or in downlink control information.

Aspect 14: The method of any of aspects 11 through 13, wherein the indication includes at least one of an index of the second PRACH occasion, time-frequency information of the second PRACH occasion, or information relative to a reference PRACH occasion.

Aspect 15: The method of any of aspects 11 through 14, wherein transmitting the scheduled uplink message based on the timing advance value and one of the first spatial filter or the second spatial filter of the set of different spatial filters comprises: transmitting the scheduled uplink message based on the timing advance value and the second spatial filter when the indication of the second PRACH occasion is received.

Aspect 16: The method of any of aspects 11 through 15, wherein transmitting the scheduled uplink message based on the timing advance value and one of the first spatial filter and the second spatial filter of the set of different spatial filters comprises: transmitting the scheduled uplink message based on the timing advance value and the first spatial filter when an indication of the second PRACH occasion is not provided to the UE.

Aspect 17: The method of any of aspects 11 through 16, wherein receiving the random access response message comprises: receiving the random access response message based on a third spatial filter associated with the first spatial filter.

Aspect 18: The method of any of aspects 11 through 17, further comprising: receiving a contention resolution message in response to the scheduled uplink message based on a third spatial filter associated with the first spatial filter or a fourth spatial filter associated with the second spatial filter.

Aspect 19: The method of any of aspects 11 through 18, wherein the random access response message is included in a set of random access response messages, wherein the set of random access response messages are based on a second set of different spatial filters associated with the set of different spatial filters, wherein receiving the random access response message including at least the timing advance value comprises: receiving the random access response message based on the RA-RNTI, wherein one or more downlink control channels associated with the set of random access response messages are scrambled based on the RA-RNTI.

Aspect 20: The method of any of aspects 11 through 19, wherein the random access response message is included in a set of random access response messages, wherein the set of random access response messages are based on a second set of different spatial filters associated with the set of different spatial filters, wherein receiving the random access response message including at least the timing advance value comprises: determining different RA-RNTIs based on different PRACH occasions associated with the plurality of PRACH signals; and monitoring a control channel associated with the random access response message based on the different RA-RNTIs and a third set of different spatial filters until the random access response message is successfully received.

Aspect 21: An apparatus for wireless communication, comprising: a memory; and at least one processor coupled to the memory and configured to: receive a plurality of physical random access channel (PRACH) signals using a set of different spatial filters, each of the plurality of PRACH signals being received during a respective PRACH occasion of a plurality of PRACH occasions; transmit one or more random access response messages including at least a timing advance value; and receive a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal received in a second PRACH occasion, where the second PRACH signal is associated with the timing advance value.

Aspect 22: The apparatus of aspect 21, wherein the at least one processor is further configured to: transmit an indication of the second PRACH occasion, wherein the second PRACH occasion enables identification of the second PRACH signal associated with the timing advance value.

Aspect 23: The apparatus of aspect 21 or 22, wherein the indication of the second PRACH occasion is included in the one or more random access response messages or in downlink control information.

Aspect 24: The apparatus of any of aspects 21 through 23, wherein the indication includes at least one of an index of the second PRACH occasion, time-frequency information of the second PRACH occasion, or information relative to a reference PRACH occasion.

Aspect 25: The apparatus of any of aspects 21 through 24, wherein the at least one processor configured to receive the scheduled uplink message based on the timing advance value and one of the first spatial filter or the second spatial filter of the set of different spatial filters is further configured to: receive the scheduled uplink message based on the timing advance value and the second spatial filter when the indication of the second PRACH occasion is transmitted.

Aspect 26: The apparatus of any of aspects 21 through 25, wherein the at least one processor configured to receive the scheduled uplink message based on the timing advance value and one of the first spatial filter and the second spatial filter of the set of different spatial filters is further configured to: receive the scheduled uplink message based on the timing advance value and the first spatial filter when an indication of the second PRACH occasion is not transmitted.

Aspect 27: The apparatus of any of aspects 21 through 26, wherein the at least one processor configured to transmit the one or more random access response messages is further configured to: transmit the one or more random access response messages based on a third spatial filter associated with the first spatial filter.

Aspect 28: The apparatus of any of aspects 21 through 27, wherein the one or more random access response messages is transmitted based on a second set of different spatial filters associated with the set of different spatial filters, wherein the at least one processor configured to transmit the one or more random access response messages including at least the timing advance value is further configured to: transmit the one or more random access response messages based on the RA-RNTI, wherein one or more downlink control channels associated with the one or more random access response messages are scrambled based on the RA-RNTI.

Aspect 29: The apparatus of any of aspects 21 through 28, wherein the one or more random access response messages is transmitted based on a second set of different spatial filters associated with the set of different spatial filters, wherein the at least one processor configured to transmit the one or more random access response messages including at least the timing advance value is further configured to: determine different RA-RNTIs based on different PRACH occasions associated with the plurality of PRACH signals; and transmit each of the one or more random access response messages based on the different RA-RNTIs and the second set of different spatial filters.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. The term “hop” as used herein refers to a frequency hop and may be used interchangeably with the term frequency hop. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication, comprising:
a memory; and
at least one processor coupled to the memory and configured to:
transmit a plurality of physical random access channel (PRACH) signals using a set of different spatial filters, each of the plurality of PRACH signals being transmitted during a respective PRACH occasion of a plurality of PRACH occasions;
receive a random access response message including at least a timing advance value; and
transmit a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value.

2. The apparatus of claim 1, wherein the at least one processor is further configured to:
receive an indication of the second PRACH occasion, wherein the second PRACH occasion enables identification of the second PRACH signal associated with the timing advance value.

3. The apparatus of claim 2, wherein the indication of the second PRACH occasion is included in the random access response message or in downlink control information.

4. The apparatus of claim 2, wherein the indication includes at least one of an index of the second PRACH occasion, time-frequency information of the second PRACH occasion, or information relative to a reference PRACH occasion.

5. The apparatus of claim 2, wherein the at least one processor configured to transmit the scheduled uplink message based on the timing advance value and one of the first spatial filter or the second spatial filter of the set of different spatial filters is further configured to:
transmit the scheduled uplink message based on the timing advance value and the second spatial filter when the indication of the second PRACH occasion is received.

6. The apparatus of claim 1, wherein the at least one processor configured to transmit the scheduled uplink message based on the timing advance value and one of the first spatial filter and the second spatial filter of the set of different spatial filters is further configured to:
transmit the scheduled uplink message based on the timing advance value and the first spatial filter when an indication of the second PRACH occasion is not provided to the apparatus.

7. The apparatus of claim 1, wherein the at least one processor configured to receive the random access response message is further configured to:
receive the random access response message based on a third spatial filter associated with the first spatial filter.

8. The apparatus of claim 1, wherein the at least one processor is further configured to:
receive a contention resolution message in response to the scheduled uplink message based on a third spatial filter associated with the first spatial filter or a fourth spatial filter associated with the second spatial filter.

9. The apparatus of claim 1, wherein the random access response message is included in a set of random access response messages, wherein the set of random access response messages are based on a second set of different spatial filters associated with the set of different spatial filters, wherein the at least one processor configured to receive the random access response message including at least the timing advance value is further configured to:
receive the random access response message based on the RA-RNTI, wherein one or more downlink control channels associated with the set of random access response messages are scrambled based on the RA-RNTI.

10. The apparatus of claim 1, wherein the random access response message is included in a set of random access response messages, wherein the set of random access response messages are based on a second set of different spatial filters associated with the set of different spatial filters, wherein the at least one processor configured to receive the random access response message including at least the timing advance value is further configured to:
determine different RA-RNTIs based on different PRACH occasions associated with the plurality of PRACH signals; and
monitor a control channel associated with the random access response message based on the different RA-RNTIs and a third set of different spatial filters until the random access response message is successfully received.

11. A method of wireless communication of a user equipment (UE), comprising:
transmitting a plurality of physical random access channel (PRACH) signals using a set of different spatial filters, each of the plurality of PRACH signals being transmitted during a respective PRACH occasion of a plurality of PRACH occasions;
receiving a random access response message including at least a timing advance value; and
transmitting a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal transmitted in a second PRACH occasion, where the second PRACH signal is associated with the timing advance value.

12. The method of claim 11, further comprising:
receiving an indication of the second PRACH occasion, wherein the second PRACH occasion enables identification of the second PRACH signal associated with the timing advance value.

13-15. (canceled)

16. The method of claim 11, wherein transmitting the scheduled uplink message based on the timing advance value and one of the first spatial filter and the second spatial filter of the set of different spatial filters comprises:
transmitting the scheduled uplink message based on the timing advance value and the first spatial filter when an indication of the second PRACH occasion is not provided to the UE.

17. The method of claim 11, wherein receiving the random access response message comprises:
receiving the random access response message based on a third spatial filter associated with the first spatial filter.

18. The method of claim 11, further comprising:
receiving a contention resolution message in response to the scheduled uplink message based on a third spatial filter associated with the first spatial filter or a fourth spatial filter associated with the second spatial filter.

19. The method of claim 11, wherein the random access response message is included in a set of random access response messages, wherein the set of random access response messages are based on a second set of different spatial filters associated with the set of different spatial filters, wherein receiving the random access response message including at least the timing advance value comprises:
receiving the random access response message based on the RA-RNTI, wherein one or more downlink control channels associated with the set of random access response messages are scrambled based on the RA-RNTI.

20. The method of claim 11, wherein the random access response message is included in a set of random access response messages, wherein the set of random access response messages are based on a second set of different spatial filters associated with the set of different spatial filters, wherein receiving the random access response message including at least the timing advance value comprises:
determining different RA-RNTIs based on different PRACH occasions associated with the plurality of PRACH signals; and
monitoring a control channel associated with the random access response message based on the different RA-RNTIs and a third set of different spatial filters until the random access response message is successfully received.

21. An apparatus for wireless communication, comprising:
a memory; and
at least one processor coupled to the memory and configured to:
receive a plurality of physical random access channel (PRACH) signals using a set of different spatial filters, each of the plurality of PRACH signals being received during a respective PRACH occasion of a plurality of PRACH occasions;
transmit one or more random access response messages including at least a timing advance value; and
receive a scheduled uplink message based on the timing advance value and one of a first spatial filter and a second spatial filter of the set of different spatial filters, wherein the first spatial filter is associated with a first PRACH signal transmitted in a first PRACH occasion associated with a random access-radio network temporary identifier (RA-RNTI), and wherein the second spatial filter is associated with a second PRACH signal received in a second PRACH occasion, where the second PRACH signal is associated with the timing advance value.

22. The apparatus of claim 21, wherein the at least one processor is further configured to:
transmit an indication of the second PRACH occasion, wherein the second PRACH occasion enables identification of the second PRACH signal associated with the timing advance value.

23-25. (canceled)

26. The apparatus of claim 21, wherein the at least one processor configured to receive the scheduled uplink message based on the timing advance value and one of the first spatial filter and the second spatial filter of the set of different spatial filters is further configured to:
receive the scheduled uplink message based on the timing advance value and the first spatial filter when an indication of the second PRACH occasion is not transmitted.

27-30. (canceled)
